(19) United States
(12) Patent Application Publication
(10) Pub. No.: US 2015/0142398 A1
(43) Pub. Date: May 21, 2015

(54) METHODS FOR A MULTI-SCALE DESCRIPTION OF THE ELECTRONIC STRUCTURE OF MOLECULAR SYSTEMS AND MATERIALS AND RELATED APPLICATIONS

(71) Applicants: CALIFORNIA INSTITUTE OF TECHNOLOGY, Pasadena, CA (US); UNIVERSITY OF BRISTOL, Bristol (GB)

(72) Inventors: Thomas F MILLER, III, PASADENA, CA (US); Frederick R MANBY, PASADENA, CA (US)

(21) Appl. No.: 14/549,465

(22) Filed: Nov. 20, 2014

Related U.S. Application Data
(60) Provisional application No. 61/906,775, filed on Nov. 20, 2013.

(51) Int. Cl. G06F 19/00; G06T 7/20

(52) U.S. Cl. CPC G06F 19/701; G06T 7/20
USPC 703/2

(57) ABSTRACT

A method for simulating a molecular system involving partitioning the system into a plurality of subsystems at the level of one-particle basis functions and applying different mean-field levels of accuracy to the subsystems is described. One or more subsystems are treated with more computationally costly mean-field methods than the other subsystems in the molecular system.

### CROSS REFERENCE TO RELATED APPLICATIONS

The present application claims priority to U.S. Provisional Application No. 61/906,775 entitled “Embedded Mean Field Method for the Seamless, Multi-Scale Description of the Electronic Structure of Molecular Systems and Materials” filed on Nov. 20, 2013 with docket number CIT 6737 P the disclosure of which is incorporated by reference in its entirety. The present application is also related to International Application S/N ______ entitled “Methods for a Multiscale description of the electronic structure of molecular systems and Materials and related applications” filed on Nov. 20, 2014 with docket number P1565-PCT, the disclosure of which is herein incorporated by reference in its entirety.

### TECHNICAL FIELD

The present disclosure relates to a multi-level partitioning description of the electronic structure of molecular systems and materials and related applications.

In particular, the present disclosure relates to methods for treating the electronic structures of the molecular systems and materials and related applications.

### BACKGROUND

Computational modeling of chemically reactive systems in the condensed phase faces challenges from the perspective of electronic structure theory.

Applications involving chemical reactions such as hydrogen transfer catalysis in enzymes, metal dendrite formation at electrolyte/electrode interfaces, and the decomposition of crystalline high energy density materials combine large system sizes with subtle molecular interactions and chemical reactions.

In particular, many of such applications involve multiple dynamical timescales and electronically non-adiabatic effects. The development of new methods to perform reliable, on-the-fly electronic structure calculations at a computational cost that makes feasible the simulation of long-timescale dynamics in large systems remains the central challenge in chemistry.

### SUMMARY

Provided herein are embedded mean field (EMF) methods which allow in several embodiments treating the electronic structures of molecular systems and materials at different mean-field levels of accuracy in order to create a high accuracy to computational cost ratio that make feasible the simulation of long-timescale dynamics in large systems.

According to a first aspect, a system and method are described herein for constructing an energy model for a molecular system, said method comprising: generating, on a computer, a one-particle basis set for the molecular system; partitioning the molecular system at a basis set level into a plurality of partitions comprising a first partition and a second partition; estimating, on the computer, a total energy of the molecular system by combining mean-field quantum mechanical calculations that involve self-consistent system optimization of a density matrix for a combination of an entirety of the first and second partitions, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost; and storing, on the computer, at least one value corresponding to the total energy.

According to a second aspect, a system and method are described herein for constructing an energy model for a molecular system, said method comprising: generating, on a computer, a one-particle basis set for the molecular system; partitioning the molecular system at a basis set level into a multiple partitions; estimating, on the computer, a total energy of the molecular system by combining mean-field quantum mechanical calculations that involve self-consistent system optimization of a density matrix for a combination of an entirety of the multiple partitions, the mean-field quantum mechanical calculations being of different levels of computational cost for each of the multiple partitions; deriving a density matrix from the total energy; and storing, on the computer, at least one value corresponding to the total energy.

According to a third aspect, a system and method are described herein for selecting a solvent for a compound presenting an acid, the method comprising: generating, on a computer, a first one-particle basis set associated with a protonated form of the acid; partitioning the protonated form at a basis set level into a first partition of the protonated form, the first partition comprising a hydrogen-oxygen bond, and into a second partition of the protonated form; generating, on the computer, a second one-particle basis set associated with a deprotonated form of the acid; partitioning the deprotonated form at the basis set level into a first partition of the deprotonated form, the first partition of the deprotonated form comprising a portion of the deprotonated form of the acid where the hydrogen-oxygen bond of the protonated form was broken to form the deprotonated form, and into a second partition of the protonated form; estimating, on the computer, a first total energy by combining mean-field quantum mechanical calculations that involve self-consistent system optimization of a first density matrix for a combination of an entirety of the first and second partitions of the protonated form, the mean-field quantum mechanical calculations being of a first level of computational cost for the first partition of the protonated form and of a second level of computational cost for the second partition of the protonated form, the first level of computational cost being higher than the second level of computational cost such that a computational cost of the estimating is lower than if the second level of computational cost were equal to the first level of computational cost; estimating, on the computer, a second total energy by combining mean-field quantum mechanical calculations that involve self-consistent system optimization of a second density matrix for a combination of an entirety of the first and second partitions of the deprotonated form, the mean-field quantum mechanical calculations being of the first level of computational cost for the first partition of the deprotonated form and of the second level of computational cost for the second partition of the deprotonated form; calculating a deprotonation energy from the first total energy and the second total energy; calculating a pKa value of the acid from the deprotonation energy; and selecting the solvent for the compound based on the pKa value.

According to a fourth aspect, a system and method are described herein for determining a total energy of a molecular system in an external field, said method comprising: generating, on a computer, a one-particle basis set associated with the molecular system; partitioning the molecular system at a basis set level into a first partition and a second partition; estimating, on the computer, a total energy of the molecular system by combining mean-field quantum mechanical calculations that involve self-consistent system optimization of a density matrix for a combination of an entirety of the first and second partitions of the one-particle basis set, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost, the self-consistent system optimization including interactions of the system with the external field; and storing, on the computer, at least one value corresponding to the total energy.

According to a fifth aspect, a system and method are described herein for constructing a model of time dependent behavior for a molecular system, said method comprising: generating, on a computer, a one-particle basis set for a configuration of the molecular system; partitioning the molecular system at a basis set level into a first partition and a second partition, wherein the first partition and the second partition each correspond to disjoint subsets of the one-particle basis set; estimating, on the computer, a total energy of the molecular system by combining mean-field quantum mechanical calculations that involve self-consistent system optimization of a density matrix for a combination of an entirety of the first and second partitions of the basis set, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost; and calculating forces within the molecular system from a gradient, with respect to nuclear coordinates of the molecular system, of the total energy of the molecular system; generating a one-particle basis set for a new configuration of the system at a consecutive time step, the new configuration being based on the forces being applied to the molecular system in the configuration; and repeating the generating, the partitioning, the estimating, and the calculating for the new configuration.

According to a sixth aspect, a system and method are described herein for optimizing geometry of a molecular system, said method comprising: generating, on a computer, a one-particle basis set associated with the molecular system of a particular geometry; partitioning the molecular system of the particular geometry at a basis set level into a first partition and a second partition; estimating, on the computer, a total energy of the molecular system by combining mean-field quantum mechanical calculations that involve self-consistent system optimization of a density matrix for a combination of an entirety of the first and second partitions, the mean-field quantum mechanical calculations being of a first level of accuracy for the first partition and a second level of accuracy for the second partition, the first level of accuracy being higher than the second level of accuracy such that a computational cost of the estimating is lower than if the second level of accuracy were equal to the first level of accuracy; repeating the generating, the partitioning, and the estimating for the molecular system in at least one other geometry; and optimizing the geometry of the molecular system based on the total energies.

According to a seventh aspect, a system and method are described herein for creating an enzyme from a non-enzymatic protein, said method comprising: procuring a sample of the non-enzymatic protein; determining a reaction to be catalyzed by the enzyme; determining a transition state of the reaction; building a nuclear configuration associated with a molecular system, the molecular system comprising the sample and the transition state; generating, on a computer, a one-particle basis set for the nuclear configuration; partitioning the nuclear configuration at a basis set level into a first partition and a second partition; estimating, on the computer, a total energy of the molecular system by combining mean-field quantum mechanical calculations that involve self-consistent system optimization of a density matrix for a combination of an entirety of the first and second partitions, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost; storing, on the computer, the total energy; determining a modification to the non-enzymatic protein; building a new nuclear configuration associated with a new molecular system, the new molecular system comprising: the transition state, and the non-enzymatic protein with the modification; partitioning the new nuclear configuration at a basis set level into a new first partition and a new second partition; estimating, on the computer, a new total energy of the new nuclear configuration by combining mean-field quantum mechanical calculations that involve self-consistent system optimization of a new density matrix for a combination of an entirety of the new first and new second partitions, the mean-field quantum mechanical calculations being of the first level of computational cost for the new first partition and the second level of computational cost for the new second partition; storing, on the computer, the new total energy; determining if the new total energy is lower than the total energy; and if the new total energy is lower than the total energy, applying the modification to the non-enzymatic protein.

In some embodiments, the EMF methods herein described can be used in methods to control one or more chemical reactions, in methods to engineer a compound and/or material or in methods to engineer a combination of compounds/molecules material to have a certain desired reactivity states or effect.

For example, according to an eighth aspect, the EMF methods can be used in a method for controlling a reaction between one or more reagents. In particular, the method can comprise constructing an energy model for a molecular system of the reaction according to a EMF method herein described to obtain one or more total energy values for the reaction; and selecting an energy value (e.g. a specific value or a range of values) for the molecular system corresponding to a predetermined reaction result. The method can further comprise selecting the reaction settings corresponding to the selected energy value; and selecting the number of reagents, type of reagents, chemical structure of the reagents and/or related concentration, and/or selecting the reaction conditions (such temperature, pH, external fields, buffers, ionic strength) to obtain the selected reaction setting.

In particular, the energy value in a method to control a reaction herein described, can be selected to correspond to several chemical and/or physicochemical state of the reactants, reaction intermediates and/or of the related products, resulting in reaction features, such as: the making or breaking of a bond (e.g. covalent bond or ionic bond), the reaction rate, the product yield, the chemical and/or structural nature of the product, and additional features identifiable by a skilled person upon reading of the present disclosure.

According to a ninth aspect, the EMF methods can be used in a method for engineering a compound to control its reactivity and/or physicochemical state. The method can comprise: constructing an energy model for a molecular system of the compound according to EMF methods herein described to obtain one or more total energy values for the compound and selecting an energy value (e.g. a specific value or a range of values) for the molecular system corresponding to a predetermined compound structure. The method can further comprise selecting structural features of the compound corresponding to the selected energy value engineering the compound having the selected structural features (e.g. polarity, hydrophobicity, or hydrophilicity of the compounds or portions thereof; number, positioning, and orientation of functional groups; and additional features identifiable by a skilled person) corresponding to the selected energy value.

In particular, the energy value for methods to engineer a compound herein described, can be selected to correspond to a compound structure that is associated with one or more chemical and/or physicochemical states of the compound, such as the reactivity of the compound or portions thereof (per se or in combination with one or more additional compounds or environment), the thermodynamic stability of the compound et al., and additional states identifiable by a skilled person upon reading of the present disclosure.

According to a tenth aspect, the EMF methods can be used in a method for engineering a material to have one or more chemical and/or physicochemical properties. The method can comprise: constructing an energy model for a molecular system of the material according to EMF methods herein described to obtain one or more total energy values for the compound and selecting an energy value (e.g. a specific value or a range of values) for the molecular system corresponding to a predetermined material configuration. The method can further comprise selecting structural features of the material corresponding to the selected energy value engineering the material having the selected structural features (e.g. crystallinity, composition number and chemical nature of the interactions between the components, and additional features identifiable by a skilled person) corresponding to the selected energy value.

In particular, the energy value, in a method to engineer a material herein described, can be selected to correspond to a material configuration that is associated with one or more chemical and/or physicochemical properties of the material, such as conductivity, ability to absorb light, tensile strength, hardness, and additional properties identifiable by a skilled person upon reading of the present disclosure.

According to an eleventh aspect, the EMF methods can be used in a method for engineering a combination of compounds, molecules and/or material to have a desired reactivity, state or effect. The method can comprise: constructing an energy model for a molecular system of the combination according to the EMF methods herein described to obtain one or more total energy values for the combination and selecting an energy value (e.g. a specific value or a range of values) for the molecular system corresponding to a predetermined state of the combination. The method can further comprise selecting an arrangement of the compounds, molecules, and/or material corresponding to the selected energy value; and selecting the structural and/or physical features of the compounds, molecules and/or material, as well as the related positioning one with respect to the other, in order to obtain the selected arrangement.

In particular, the energy value in a method to engineer a combination of compounds, molecules and/or material herein described, can be selected to correspond to an arrangement that is associated with one or more chemical and/or physicochemical properties of the combination, such as: the complementarity of the compounds, molecules and/or material forming the combination; the stability of the combination; and additional properties identifiable by a skilled person upon reading of the present disclosure.

The EMF methods and related components, methods and systems herein described, allow in several embodiments to, for a partitioned basis set: introduce no constraints on the number of electrons in any partition and unambiguously return the same number of electrons in each partition; capture quantum entanglement between partitions at the level of mean-field approximation by making no assumption that any partition is in a pure state; require no external or system-dependent parameters beyond the determination of the partition; implement the linear response theory more efficiently.

The EMF methods and related components, methods and systems herein described can be used in connection with applications wherein multi-level description of molecular systems for, is desired. Exemplary applications comprise reactions at solid or metal surfaces, bioinorganic or organometallic chemistry, homogenous or heterogeneous catalytic processes, chemical processes in batteries and fuel cells and additional applications which are identifiable by a skilled person.

The EMF methods can be implemented in combination with any classical or quantum molecular simulation tool that utilizes Born-Oppenheimer potential energy surfaces, including molecular dynamics, Monte Carlo simulation, energy minimization and docking. Software realizations of the disclosed methods will enable simulation, study and design of chemical, material and biological systems. Application domain include heterogenous catalysis, homogenous catalysis with splitting of ligands, semiconductor etching, processes at semiconductor surfaces, chemistry on and among nanoparticles, chemistry at battery electrodes, graphene chemistry, biocatalysis, and many other application areas.

The details of one or more embodiments of the present disclosure are set forth in the description below. Other features, objects, and advantages will be apparent from the description and from the claims.

### BRIEF DESCRIPTION OF DRAWINGS

The accompanying drawings, which are incorporated into and constitute a part of this specification, illustrate one or more embodiments of the present disclosure and, together with the detailed description and the examples, serve to explain the principles and implementations of the disclosure.

FIG. 1 provides a control-flow diagram that represents one implementation of EMF methods and its application for designing and making a product for a desired reaction.

FIG. 2 shows a comparison of the error relative to PNE of deprotonation of methanol, obtained using (i) LDA on the full system (open circles) and (ii) PBE on —OH embedded in an LDA environment using the EMF scheme.

FIGS. 3A-3B show energy profile for the symmetric SN2 reaction of F— with n-propyl fluoride, with all energies measured relative to the transition state (TS) configuration. FIG. 3B shows example results obtained using (i) B3LYP on the full system (open circles), (ii) LDA on the full system (crosses), (iii) B3LYP energies evaluated for the LDA density (open diamonds), and (iv) B3LYP-in-LDA embedding using the EMF scheme with two different active regions. FIG. 3A shows the example two different active regions used for FIG. 3B. All calculations performed using the 6-311G(d) basis set for all atoms, with geometries from the B3LYP level.

FIGS. 4A-4B show an example of the error in B3LYP-in-LDA embedding using the EMF scheme as a function of the number of carbons included in the active region for the exchange of fluoride to a hydride in (a) 1-fluorodecane and (b) 1-fluoro-1,3,5,7,9-decapentaene. FIG. 4A shows examples of various embedded subsystem sizes for the alkane system; the subsystems for the conjugated alkene system are similarly defined. All errors are computed relative to reference B3LYP calculations. All calculations performed using the 6-311G(d) basis set for all atoms, with geometries from the B3LYP level.

FIGS. 5A-5B show torsional energy profile (FIG. 5B) for the bibenzyl molecule (FIG. 5A), obtained using (i) B3LYP on the full system (open circles), (ii) LDA on the full system (crosses), and (iii) B3LYP-in-LDA embedding using the EMF scheme with three different active regions. All calculations performed using the 6-311G(d) basis set for all atoms, with geometries from the B3LYP level.

FIGS. 6A-6D show an example of SN2 reaction from haloalkane to alcohol. The dotted lines of 6A and 6B: range within 1 kcal/mol. FIG. 6A shows error in reaction the energy compared to full DFT of the different DFT-in-DFT schemes, FIG. 6B shows error comparison of the different embedding schemes, FIG. 6C shows relative CPU time per SCF iteration for the reactant of the different DFT-in-DFT schemes (time for full DFT is normalized to be 1), and FIG. 6D shows the reactant on the top of the figure and the product on the bottom of the figure.

FIGS. 7A-7D show an example of hydrogenation at the terminal carbons of conjugated alkene. The dotted lines of 7A and 7B: range within 1 kcal/mol. FIG. 7A: Error in reaction the energy compared to full DFT of the different DFT-in-DFT schemes, FIG. 7B: Error comparison of the different embedding schemes, FIG. 7C: Relative CPU time per SCF iteration for the reactant of the different DFT-in-DFT schemes (time for full DFT is normalized to be 1), and FIG. 7D shows the reactant on the top of the figure and the product on the bottom of the figure.

FIGS. 8A-8D show an example of Diels-Alder reaction between conjugated linear alkene chain and 1,3-butadiene. The dotted lines in 8A and 8B show a range within 1 kcal/mol. FIG. 8A shows the error in reaction the energy compared to full DFT of the different DFT-in-DFT schemes, FIG. 8B shows the error comparison of the different embedding schemes, FIG. 8C shows the relative CPU time per SCF iteration for the product of the different DFT-in-DFT schemes (time for full DFT is normalized to be 1), and FIG. 8D shows the reactant on the top of the figure and the product on the bottom of the figure.

FIGS. 9A-9D show an example of hydrogenation of naphthalene. The dotted lines in 9A and 9B indicate range within 1 kcal/mol. FIG. 9A shows the error in reaction the energy compared to full DFT of the different DFT-in-DFT schemes, FIG. 9B shows the error comparison of the different embedding schemes, FIG. 9C shows the relative CPU time per SCF iteration for the reactant of the different DFT-in-DFT schemes (time for full DFT is normalized to be 1), and FIG. 9D shows the reactant on the top of the figure and the product on the bottom of the figure.

FIGS. 10A-10D show an example of deprotonation energy of carboxylic acid. Dotted lines in 10A and 10B show range within 1 kcal/mol. FIG. 10A shows the error in reaction the energy compared to full DFT of the different DFT-in-DFT schemes, FIG. 10B shows error comparison of the different embedding schemes, FIG. 10C shows relative CPU time per SCF iteration for the reactant of the different DFT-in-DFT schemes (time for full DFT is normalized to be 1), and FIG. 10D shows the reactant on the top of the figure and the product on the bottom of the figure.

FIG. 11 illustrates an embodiment of hardware implementation for the present disclosure.

### DETAILED DESCRIPTION

Provided herein are embedded mean field methods which allow in several embodiments treating the electronic structures of the molecular systems and materials at different mean-field levels of accuracy (alternatively, levels of computational cost).

Finding a solution to any electronic structure problem requires a compromise between accuracy and feasibility that is dictated by the system size. The current disclosure is directed to Embedded Mean Field (EMF) methods for the seamless, multi-level description of the electronic structure of complex molecular systems and materials with improved accuracy and at a reduced computational cost that makes feasible the simulation of long-timescale dynamics in large systems.

The EMF methods allow for partitioning of a complex molecular system into two or more subsystems at the particle level and the treatment of each subsystem within the complex molecular system at different mean-field levels of accuracy, in which subsystems are identified by subsets of one-particle basis sets. The EMF methods are distinguished from previous methods [references 1-4] by its fully consistent treatment of coupling effect between the subsystems, and the fact that electron-number fluctuations between subsystems are fully accounted for at the mean-field level. Detailed description of the EMF method, as well as numerical demonstrations, is provided in the following sections.

The term “model” or “modeling” used herein is a software construct of a molecular system. A model contains numerous variables that characterize the system being studied. Simulation is done by adjusting these variables and observing how the changes in variables can affect the outcomes predicted by the model. A common feature of various modeling techniques requires an atomistic- or even electronic-level description of molecular systems of interest.

The term “molecular system” used herein refers to a combination of atomic and/or subatomic particles possibly linked by one or more chemical bonds and possibly forming chemical and/or biological compounds, molecules, material, or combination thereof.

In particular, a molecular system in the sense of the disclosure can refer to a chemical and/or biological compounds, molecules, materials, or combination thereof comprising interacting particles, such as atoms or electrons, possibly taking the form of chemical compounds or combinations thereof consisting of a small number of atoms, to polymeric biological macromolecules and material assemblies. The particles in a molecular system, in the sense of the disclosure, can be interacting and be subjected to attractive repulsive forces which can result in some instances in formation of one or more bonds. In particular in some instances, at least some of the particles in a molecular system can be either covalently or non-covalently bonded and interact with one another through nuclear and electron interactions. Examples of a molecular system include an organic molecule, an inorganic molecule, an organic polymer, an inorganic polymer, a protein, a nucleic acid, or a combination thereof.

The term “material” used herein refers to an organic or inorganic substance, which can be a form of matter that has constant chemical composition and characteristic properties. In particular chemical substances can exist in various physical forms such as solids, liquids, gases, and plasma, and may change between these phases of matter with changes in temperature or pressure. In some instances chemical reactions can convert one chemical substance into another.

In embodiments herein described, nuclear configuration of a molecular system determines the molecular geometry by describing the three-dimensional arrangement of the particles in the molecular system. The nuclear configuration provides a description of each particle in a molecule in terms of atomic number, bond length, bond angle, and dihedral angle, and related information regarding atomic orientations and connectivity in space. In certain embodiments, the nuclear configuration of a molecular system can contain additional information such as nuclear coordinates, atomic masses and velocities. The number of variables contained in a molecular system can be modified in order to observe how the modification may affect system features of the molecular system.

Computational models introduce various levels of approximation to characterize the molecular system of interest. For small systems (<500 atoms), multi-picosecond molecular dynamics (MD) trajectories that utilize on-the-fly Kohn-Sham (KS) density functional theory (DFT) potentials may be employed [references 5-7], and MD trajectories performed using wavefunction-based ab initio methods such as Hartree-Fock (HF), second-order Moller-Plesset (MP2), coupled-cluster single/double (CCSD), and many other methods, are also feasible [reference 8].

The term “molecular dynamics” or “classical molecular dynamics” is a computer simulation approach of physical movements of particles, in particular, atoms, in a many-body molecular system. In molecular dynamics, a simulation trajectory is generated for each atom according to classical mechanics by following Newton's law of motion:

$${m}_{i} \frac{{d}^{2} {r}_{i} ( t )}{d {t}^{2}} = {F}_{i} ( r ) = - {∇}_{i} V ( r ) \qquad ( 1 )$$

where the force Fᵢ(r) on atom i is due to interactions with all other atoms in the given system and m, is the mass of atom i. The force can be calculated from the gradient or first derivative of the interatomic potential energy V(r) with respect to the nuclear coordinates of the molecular system. The potential energy V(r) can be calculated using either classical molecular mechanics methods or first-principle electronic structure theories, such as HF, DFT, MP2 and many other methods identifiable to a person in the skilled art. Therefore, given a starting conformation of a molecular system with a set of initial positions and velocities, the above equation describes the evolution of the simulated system in time space in a deterministic fashion. A “simulation trajectory” used herein refers to the nuclear coordinates of the particles or atoms in the molecular system that are propagated in time by a time step in the simulation method over the course of the simulation. A “classical molecular dynamics trajectory” is therefore referred to as a “simulation trajectory” generated using the classical molecular dynamics method. Molecular dynamics can be used to estimate equilibrium and dynamic properties of a complex system that cannot be calculated analytically.

Among the conventional computational models, the robustness and generality of first-principles electronic structure methods come at enormous computational expense. The first-principle electronic structure theories or methods, also referred to as ab initio quantum mechanics methods, are based on the solution of the Schrödinger equation that describes the motions of the electrons and nuclei in a molecular system from first principles. These methods calculate molecular energy and associated properties of a given molecular system on the basis of fundamental physical principles, namely electronic and nuclear structures of atoms and molecules.

For example, a typical 10 ps classical simulation of 216 water molecules using KS-DFT, one of the first-principle electronic structure methods, requires 71,000 CPU hours and at least 280 wall-clock hours on the top-ranked [reference 9] NCCS Jaguar supercomputer. Even with the approach of exoscale computing and advances in linear-scaling techniques [references 10-19], first-principles electronic structure methods remain impractical for applications involving large system sizes in a range of 10,000-100,000 atoms and long timescales about nano to microseconds.

An alternative approach to first-principle electronic structure methods is known as empirical force field methods such as molecular mechanics methods and related calculations. In molecular mechanics, a molecular system is considered as a mechanical system in which particles are connected by springs and physical forces determine the structure and dynamics of each particle. The total energy of a molecular system, also known as potential energy, is evaluated empirically with respect to the nuclei in the molecular system with the electrons treated as implicit variables of this potential, rather than explicitly treated in the first-principle electronic structure theories. Therefore, molecular mechanics involves construction of a potential energy function from a large body of experimental data, such as crystal structure geometries, vibrational and microwave spectroscopy, heats of formation, and so on.

Computations based on first-principle electronic structure methods are carried out numerically using a set of one-particle basis functions. The term “one-particle basis function” or “one-particle basis set” is defined as a set of known functions used to represent an unknown function, such as the molecular orbitals. Such function can be used to calculate the probability of finding any electron of an atom in any specific region around the atom's nucleus. The molecular orbital can be obtained by combining one-particle basis functions in a molecule. Molecular orbital is generally defined as a one-particle wavefunction, obtained as an eigenfunction of a model one-particle Hamiltonian operator.

There are hundreds of one-particle basis sets, including atom-centered basis sets in which basis set functions are centered on atoms, such as some Gaussian-function orbitals and non-exponential Slater-type orbitals (STO), and basis sets that are not centered on atoms, such as plane wave basis sets, wavelets, splines, and exponential Slater-type orbital basis functions.

Among atom-centered basis sets, also referred to as “atomic orbital basis sets”, the smallest are called minimal basis sets that consist of a minimum number of basis functions required to represent all the electrons on each atom. The most common minimal basis set is STO-nG (Slater-Type Orbital, n-Gaussian), where n is an integer and represents the number of Gaussian primitive functions comprising a single basis function. Examples of minimal basis sets include but STO-3G, STO-3G*, STO-4G, STO-6G and many others identifiable to a person skilled in the art. A common addition to basis sets is the addition of polarization functions, denoted by an asterisk *. Two asterisks, **, indicate that polarization functions are also added to light atoms such as hydrogen and helium. In order to better describe the critical role of valence electrons in chemical bonding, valence orbitals are commonly represented by more than one basis function, each of which in turn is composed of a fixed linear combination of Gaussian primitive functions. Examples of such split-valence basis sets include 4-31G, 6-31G, 6-311G, and many other split-valence basis sets identifiable to a person skilled in the art. Other atomic orbital basis sets such as cc-pVDZ and cc-pVTZ are optimized to increase computational efficiency. These basis sets can be augmented with diffuse functions by adding the AUG-prefix to the basis set keyword.

In some embodiments, products of one-particle basis functions can be constructed to generate auxiliary basis sets, using the strategy that is widely known in the field, for density fitting or resolution of the identity The general term “basis sets” refers to both one-particle basis functions and auxiliary basis sets constructed from one-particle basis functions.

Methods for modeling the electronic structure of large, chemically reactive molecular systems can be generally categorized as either (i) reactive force fields or (ii) multi-level partitioning methods.

The term “reactive force fields (RFFs)” is referred to as using analytical molecular mechanics potential energy functions to allow for breaking and reforming of chemical bonds. The RFFs method, which includes the empirical valence bond (EVB) potentials of Warshel [references 20-22], Voth [references 23-26], and others [references 27, 28] and the reaxFF force field of Goddard and coworkers [reference 29], has made possible many important applications, ranging from the transport of protons across membranes to the chemical etching of silicates. One feature of RFFs is that the system is seamlessly represented as a function of changes in configuration: no artificial spatial interfaces are introduced. However, RFFs are limited by the fact that relevant interactions, and in the case of EVB methods, possible bonding connectivities, must be anticipated and parameterized for each application. Consequently, RFFs generally include dozens or even hundreds of empirical parameters, and those parameters are difficult to rapidly and reliably generalize for new applications.

The term “partitioning” or “multi-level partitioning” used herein is subdividing a given molecular system into two or more separated, smaller subsystems at the level of one-particle basis functions, each of which can be treated differently, for example, using different algorithms, levels of accuracy or levels of computational cost. For example, one region in the molecular system can be treated at a “high” level of accuracy, which is more accurate, but more computationally expensive while a surrounding region in the molecular system can be treated at a “lower” level of accuracy, which is less computationally expensive, but less accurate. Each region can be referred to as a “subsystem”. In some embodiments, the molecular system may be partitioned at the level of atoms associated with atom-centered basis sets. In some embodiments, the partitioning can be based on spatial domains in which a given particle is assigned depending on its position.

The term “subsystem” used herein is an atomic and/or subatomic representation of a portion of a given molecular system. In certain embodiments, the subsystem can be identified as a subset of one-particle basis sets for a given configuration of the molecular system. In some embodiments, the subsystem can be identified as a subset of atom-based basis sets associated with the given molecular system.

The term “high-level” or “low-level” used herein is referred to different accuracy levels of the electron structure description of the molecular system. The level of accuracy is considered equivalent to the level of computational cost for a computer implementation of the description. In general, higher level of accuracy corresponds to higher computational cost and lower level of accuracy corresponds to lower computational cost. For example, first-principle ab initio quantum mechanics methods are considered higher-level in comparison to empirical force field methods such as molecular mechanics. The term “computational cost” is typically expressed in core hours also known as CPU hours which provide necessary value estimation needed to calculate the cost of a simulation. In addition to the level of accuracy of the methods, the computational cost can be affected by a number of other factors, including the performance of the computers, the number of atoms in the molecular system under consideration, the timescale or the length of a simulation, whereas level of computational cost is independent of those factors.

As one example of the multi-level partitioning methods, the combined QM/MM (Quantum Mechanics/Molecular Mechanics) [references 30-33] approach is commonly a method of choice for modeling reactions in bio-molecular systems consisting a large number of atoms. QM methods are required for describing chemical reactions and other electronic processes, such as charge transfer. However, QM methods are restricted to systems of up to a few hundred atoms. In order to model larger systems (i.e. more atoms) over large time scales, force-field-based molecular mechanics (MM) methods are combined with the QM methods so that QM methods are used for the chemically active region, such as substrates and co-factors in an enzymatic reaction, and MM methods are used to treat the environment region, such as protein and solvent that surround the active region. Such combined methods enable the modeling of reactive systems at a reasonable computational effort while providing the necessary accuracy. In other approaches, as in the modeling of bulk materials and crack formation, the partitioning can be based on spatial domains in which a given atom is assigned to the high- or low-level partition depending on its position [references 34-36].

The term “active region” is a region in close proximity to a chemically reactive center where conformational reorganization, chemical reactions and other electronic processes, such as charge transfer, may take place. The active region can involve chemical bond breaking and reforming, angle bending, out-of-plane distortions, or other types of conformational change. For example, the core region of biomolecular systems in which quantum events such as catalytic reaction and electronic excitations occur is considered as an active region, while the peripheral regions such as protein environments, lipids, and waters that surround the active region are considered as an environment region.

As another example of the multi-level partitioning methods, projector based embedding introduces a projection operator and constrains the number of electrons in each subsystem. However, such a method is not self-consistent, and therefore introduces ambiguity regarding partitioning selection.

As yet another example, density matrix embedding theory provides a method for embedding high-level methods using mean-field density matrices. However, this method is not formulated as a minimization of a single energy function.

As yet another example, ONIOM (Our own N-layered Integrated molecular Orbital and molecular Mechanics) provides a simple multi-level energy model in which molecular mechanics method can treat the system as a whole and an ab initio method can treat the active site of interest, known as ONIOM (QM:MM). Alternatively, two different levels of ab initio quantum mechanics methods can be combined to treat two different subsystems, known as ONIOM (QM:QM). However, ONIOM does not involve self-consistent optimization of a single energy functional, and neither does it treat subsystems properly embedded in their electronic environment. The limitation associated with the ONION method includes using link atoms for treating covalent linkages across subsystems as well as the constrained number of electrons in each subsystem. In particular, atoms linked by double or triple bonds should be placed within the same ONIOM region.

In principle, the partitioning methods require less parameterization than the RFF methods to describe the chemically reactive region, since that part of the electronic structure theory problem is treated using wavefunction-based ab initio methods. Nonetheless, these methods have clear limitations. In particular, calculation of the electronic structure must correctly account for the interfaces between the high- and low-level subsystems. Using QM/MM calculations for enzymes as an example, the molecular groups in the active site where an enzymatic reaction takes place are often capped with hydrogen atoms, although the active site in the full system might be covalently bonded to the surrounding protein scaffolding. These boundary effects can be a significant source of error in the calculated results [reference 37].

To address above limitations, attention has also been paid to the development of multi-level partitioning methods in which the high-level subsystem corresponds to a correlated wavefunction theory [references 3, 39] that accounts for explicit electron correlations and the low-level subsystem corresponds to a mean-field approximation. However, in such methods, it is necessary to specify a priori number of electrons in each subsystem and it is not possible to allow for the flow of electrons between subsystems or the fluctuation of the number of electrons between subsystems.

The “mean-field approximation” or “mean-field accuracy” or “mean-field electronic structure method” is in particular described as a method that approximates the solution for the total wavefunction of a system in terms of an anti-symmetrized product of molecular orbitals, where anti-symmetrized refers to the fact that the sign of the total wavefunction changes upon transposition of electron pairs. Both HF and KS-DFT methods correspond to examples of mean-field electronic structure methods.

The term “total energy” of a system defines the energy state of a molecular system. The total energy can be determined by various approximate solutions of the time-independent Schrödinger equation, usually with no relativistic terms included and by making assumption under the Born-Oppenheimer approximation that allows for the separation of electronic and nuclear motions.

In certain embodiments, the total energy of an atomic system can be computed by solution of the Schrödinger equation, which is defined, in the time-independent, non-relativistic, Born-Oppenheimer approximation, as follows:

\hat{H}Ψ(r₁,r₂, . . . ,r_{N})=EΨ(r₁,r₂, . . . ,r_{N}) (2)

The Hamiltonian operator, H, consists of a sum of three terms: the kinetic energy, the interaction with the external potential (Vₑₓₜ) and the electro-electron interaction (Vₑₑ). Ψ is a wavefunction, a functional describing the quantum state of a system, represented by as a linear combination of basis function. The Hamiltonian operator H is defined in the following equation:

$$\hat{H} = - \frac{1}{2} {\sum }_{i}^{N} {∇}_{i}^{2} + {\hat{V}}_{ext} + {\sum }_{i < j}^{N} \frac{1}{\vert {r}_{i} - {r}_{j} \vert} \qquad ( 3 )$$

The external potential of interest can be defined as the interaction of the electrons with the atomic nuclei:

$${\hat{V}}_{ext} = - {\sum }_{α}^{{N}_{at}} \frac{{Z}_{α}}{\vert {r}_{i} - {R}_{α} \vert} \qquad ( 4 )$$

where rᵢ is the coordinate of electron i; Z_{α} is the charge on the nucleus R_{α}. The spin coordinate can be omitted in order to simplify the notation.

The average total energy for a state specified by a particular wavefunction Ψ is the expectation value of H, E[ψ], defined in the following equation:

E[Ψ]=∫Ψ*ĤΨdr≡ [symbol] Ψ|Ĥ|Ψ [symbol] (5)

The lowest energy eigenvalue, E₀, is the ground state energy and the probability density of finding an electron with any particular set of coordinates {rᵢ} at the ground state is |ψ₀|2.

Hartree-Fock theory provides an approximate solution of the Schrödinger equation. The expression for the Hartree-Fock energy is defined as:

$${E}_{HF} = \int {φ}_{i}^{*} ( r ) ( - \frac{1}{2} {\sum }_{i}^{N} {∇}_{i}^{2} + {V}_{ext} ) {φ}_{i} ( r ) d r + \frac{1}{2} {\sum }_{i , j}^{N} \int \frac{{φ}_{i}^{*} ( {r}_{1} ) {φ}_{i} ( {r}_{1} ) {φ}_{j}^{*} ( {r}_{2} ) {φ}_{j} ( {r}_{2} )}{\vert {r}_{i} - {r}_{j} \vert} d {r}_{1} d {r}_{2} - \frac{1}{2} {\sum }_{i , j}^{N} \int \frac{{φ}_{i}^{*} ( {r}_{1} ) {φ}_{j} ( {r}_{1} ) {φ}_{i} ( {r}_{2} ) {φ}_{j}^{*} ( {r}_{2} )}{\vert {r}_{i} - {r}_{j} \vert} d {r}_{1} d {r}_{2} \qquad ( 6 )$$

in which the first term is a sum of the kinetic energy and the external potential, the second term is the classical Coulomb energy, and the third term is the exchange energy. The ground state orbitals are determined by applying the variation theorem to the above energy expression under the constraint that the orbitals are orthonormal, leading to the Hartree-Fock equation:

$$[ - \frac{1}{2} {∇}^{2} + {v}_{ext} ( r ) + \int \frac{ρ ( {r}^{′} )}{\vert r - {r}^{′} \vert} d {r}^{′} ] {φ}_{i} ( r ) + \int {v}_{x} ( r , {r}^{′} ) {φ}_{i} ( {r}^{′} ) d {r}^{′} = {ɛ}_{i} {φ}_{i} ( r ) \qquad ( 7 )$$

where V_{X} is a non-local exchange potential. The Hartree-Fock equations describe non-interacting electrons under the influence of a mean field potential consisting of the classical Coulomb potential and a non-local exchange potential. Therefore, the Hartree-Fock method is also known as self-consistent field method (SCF) in which each particle is subjected to the mean field created by all other particles.

Approximations such as electron correlation methods can be made to better represent the wavefunction and the total energy of the system. However, accurate solutions require a detailed description of the spatial variation of the wavefunction, i.e. a large basis set is required which also leads to increased expense for practical calculations. Many correlation methods have been developed for molecular calculations. However, the cost of the most commonly used methods, such as MP2, MP3 (third order MP), and CCSD, scales with the number of electrons. Due to the high computational expense, the routine application of such methods to realistic models of systems of interest is not practical.

Given that direct solution of the Schrödinger equation is not currently feasible, especially for systems of interest in condensed matter science, approximation methods such as density functional theory have been developed to make a compromise between accuracy and computational cost. In this case, instead of solving the full Schrödinger equation for the wavefunction, two-particle probability density, which is the probability of finding an electron at position r₁ and an electron at position r₂, is sufficient for the purpose of calculating the ground state energy. Therefore, the total energy can be expressed in terms of the total electron density rather than the wavefunction.

Density functional theory (DFT) provides a theoretical approach to calculating the total energy of a molecular system from the one-particle density matrix. In the Kohn-Sham implementation of DFT (KS-DFT), which resembles to the HF equation, the electronic exchange and correlation effects are included via an approximate exchange correlation functional, whose derivative with respect to the one-particle density provides an effective potential for the one-particle (i.e., HF-like) equations.

A local density approximation (LDA) is another approximation for calculating the exchange-correlation potential, which assumes that an inhomogeneous density of a molecule can be calculated using the homogeneous electron gas functional same as the local density around the electron.

Hybrid functionals are another class of approximation to the exchange-correlation function in density functional theory. The hybrid functionals incorporate a portion of exact exchange from Hartree-Fock theory with a portion of exchange and correlation from other sources. The exact exchange energy functional is expressed in terms of Kohn-Sham orbitals rather than density. One of the most commonly used exchange-correlation functional in DFT is B3LYP (Becke, three-parameter, Lee-Yang-Parr). Another commonly known exchange-correlation functional is PBE functional that mixes PBE (Perdew-Burke-Ernzerhof) exchange and correlation energy with Hartree-Fock exchange energy. Many other hybrid functionals or non-hybrid functionals such as gradient-corrected methods including PBE can also be used in the current disclosure and are identifiable to a person skilled in the art.

### Overview of the EMF Methods

### Density Matrix Form

The EMF methods are advanced from the density functional theory to better describe a chemically reactive system by partitioning the one-particle basis of the system into two or more subsystems, each subsystem treated with different levels of mean field accuracy (alternatively, levels of computational cost). Such partition imposes a block-like structure on the reduced one-particle density matrix in the one-particle basis set. For example, in a case with two subsystems, the density matrix is a 2×2 matrix that takes the form

$$D = [ \begin{matrix}{D}_{αβ}^{AA} & {D}_{αμ}^{AB} \\ & \\ & {D}_{μ v}^{BB}\end{matrix} ] \qquad ( 8 )$$

where α and β represent one-particle basis functions in one subsystem A, and μ and ν represent one-particle basis functions in the other subsystem B. In this example, the subsystem A is referred to as the active region and the subsystem B is referred to as the environment region, with the connotation that the active region is treated at a higher mean-field level of accuracy and the environment region is treated as a lower mean-field level of accuracy. More than two subsystems can be utilized, and can include multiple active and/or environment regions. The number of rows and columns of the density matrix matches the number of subsystems in the molecular system. Therefore, the density matrix for a molecular system consisting of N number of subsystems is an N×N matrix. It is noted that compared to the HF and KS-DFT, in the EMF methods the one-particle density matrix is partitioned at the level of particle basis functions with respect to the subsystems according to equation (8). For this reason, the active region and the environment region can each further comprise two or more non-contiguous sub-regions that are not adjacent or directly connected to one another. In other words, one or more active regions can be embedded in an environment region, each of which can be treated with different levels of computational cost. The density matrix shown in equation (8) describes an electronic mean-field state corresponding to a total energy of the molecular system defined below in equation (9).

The choice of the active region is usually made by chemical intuition. A minimum-size active region can be defined on chemical grounds by considering the chemical problem at hand. For example, an atom or a group of atoms that is involved in a reaction of interest can be selected, then the active region can be defined to include any atom that is within 5 Å from the selected atom or from the center of mass of the selected group of atoms. Each of the atoms in the active region is described by a set of one-particle basis functions. The EMF results can then be checked with respect to adjusting the active region, either enlarging the active region or reducing the active region.

### Energy Expression

The total EMF energy functional for the above-described system, including two subsystems A and B, is a function of the above defined density matrix D and is defined in the following equation:

$$E [ D ] = tr h \cdot D + {E}_{xc}^{1} [ D ] - {E}_{xc}^{1} [ {D}^{AA} ] + {E}_{xc}^{2} [ {D}^{AA} ] + {G}^{1} [ D ] - {G}^{1} [ {D}^{AA} ] + {G}^{2} [ {D}^{AA} ] \qquad ( 9 )$$

where h is the core Hamiltonian that represents the kinetic energy of the electrons and the external potential. The first term is defined as the trace of the product of the density matrix D and the core Hamiltonian h. E_{xc}¹ and E_{xc}² are the exchange-correlation functionals for two mean-field levels of approximation representing the low-level of approximation and the high-level of approximation, respectively. G¹ and G² include any contributions from two-electron integrals, for the low-level and the high-level approximation, respectively, such as those from the Coulomb electrostatic repulsion. It is noted that in certain embodiments any of these terms can vanish.

### Fock Operator

The Fock can be defined as the partial derivative of the total energy defined in equation (9):

$${f}_{ij} = \frac{\partial E [ D ]}{\partial {D}_{ij}} \qquad ( 10 )$$

where i and j represent index of the one-particle basis functions. Components in the Fock matrix can be obtained using standard methods familiar to a person skilled in the art. The Fock matrix fᵢⱼ, which depends on the density matrix, can be optimized iteratively using the self-consistent-field (SCF) procedure. The SCF procedure is repeated until self-consistency is achieved in the density matrix to a desired accuracy. The self-consistency is achieved, or the procedure is converged, when the new density matrix calculated from the Fock matrix fᵢⱼ is the same or within a specified convergence threshold as the density matrix calculated from the previous step. Then the resultant solution including the electron density and the total energy can be used to calculate chemical quantities of the system alone or in combination with external fields, such as the reactive energy, structurally stable geometry, dipole moment, magnetic moment, and other quantities of interest.

Therefore, in the EMF methods, the total energy of the molecular system is estimated by combining mean-field quantum mechanical calculations that involve self-consistent optimization of a single density matrix, as shown in equation (8), describing the entire molecular system combining two or more subsystems. As a result, the molecular system is self-consistently optimized as a whole using the SCF procedure with each subsystem treated at a different mean-field level of accuracy.

The EMF methods therefore disclose a full self-consistent solution to the electrons with respect to the molecular orbitals, which can be simple, efficient, and robust to achieve given the inherent structure provided by such method. In particular, the EMF methods provide a multi-level description of the electronic structure of complex molecular systems at a reduced computational cost and with improved accuracy that make feasible the simulation of long-timescale dynamics in systems consisting of large number of atoms. It is noted that the EMF method itself is an example of a mean-field method.

Since both the active region and the environment region are treated at mean-field level of accuracy, the interfaces between the high- and low-level subsystems are correctly accounted for, and the electronic energy surfaces are guaranteed to be smooth functions of the nuclear coordinates. The methods introduce no constraints on the number of electrons in any partition and unambiguously return the same number of electrons in each partition. The methods can also capture quantum entanglement between partitions at the level of mean-field approximation by making no assumption that any partition is in a pure state. As a result, the boundary effect that commonly arises in other methods such as QM/MM or ONIOM is eliminated. In addition, in comparison to other conventional methods, such as RFFs, the EMF methods require no external or system-dependent parameters beyond the determination of the partition.

Additionally, the linear response theory can be implemented more efficiently than in other formulations. Note that the linear response theory refers to the linear response of the electron density and total energy with respect to the external fields, both in time-dependent and time-independent way, as well as any higher-order responses of the energy or density.

The gradient of the EMF energy with respect to nuclear coordinates, which is required for calculation of force, can be efficiently and robustly implemented due to the full minimization of the energy with respect to the linear variational parameters. In particular, a solution of the coupled-perturbed equations is not necessary for the calculation of EMF energy gradients. The calculated force can be combined with the molecular dynamics methods to study the time evolution dynamic behavior of the molecular system. For example, the trajectories of atoms in the molecular system can be determined by numerically solving the Newton's equation for each individual atom, where forces applied on each atom can be derived from the EMF potential.

In some embodiments, different subsystems can be treated at the same mean-field level of approximation. For example, the active region and the environment region can be treated both at a higher mean-force level of accuracy (i.e. “high-level”). Alternatively, the active region and the environment region can be treated both at a lower mean-force level of accuracy (i.e. “low-level”). In such cases, the EMF methods reproduce the same result as for the mean-field calculation performed on the full system. Additionally, additional regions outside the environment regions can be treated at an even lower level of accuracy with non-EMF methods.

In some embodiments, the EMF methods can describe the active region using Kohn-Sham Density Functional Theory (KS-DFT) and the environment region using density functional tight binding (DFTB). The DFTB is an approximated density functional theory method by introducing parameters to the conventional DFT to reduce computational cost while maintaining a reasonable accuracy.

In certain embodiments herein described, the EMF methods can describe the active region using KS-DFT with better, and more costly, descriptions (i.e. “high-level”) of the one-particle basis set, the exchange-correlation functional, and the coulomb interactions and the environment region using KS-DFT with less costly descriptions (i.e. “low-level”) of one-particle basis set, the exchange-correlation functional, and the coulomb interactions. Such implementations are described below in detail in the section titled The EMF Methods Using Mixed Basis Sets.

The EMF methods can be used for multi-level approaches in which the active region is described using KS-DFT and the environment region is described using orbital-free DFT. Orbital-free DFT used herein is a non-KS implementation of DFT that involves the need for a kinetic energy functional of the density.

In certain embodiments, to improve the accuracy of the EMF method, elements of the Fock matrix can be shifted according to various algorithms. Since different levels of approximation for the active and environment regions of a general molecular system can be used, it is noted that some calculations can potentially exhibit errors in which electrons incorrectly flow between the active and environment regions. It is further noted that various algorithms can be developed in which elements of the Fock matrix are shifted by parameters that mitigate this problem. These parameters can be derived, for example, from calculations on isolated atoms, thus ensuring that the parameters are transferrable among different systems. In some embodiments, relative values for diagonal or off-diagonal matrix elements of the Fock matrix can be parameterized based on the properties of a library of test molecules or upon isolated atoms.

In certain embodiments in which the environment region is much larger than the active region, the total cost of evaluating the Fock matrix will be dominated by the cost of the calculation on the environment region. The higher-quality description for the active region is thus obtained at negligible cost.

Note that even though the EMF methods are described above using a system with two subsystems as an example, the EMF methods can be generalized and applied to systems comprised of a plurality of subsystems, with each subsystem treated with different mean-field level of accuracy.

In certain embodiments, the EMF methods can be implemented in periodic boundary conditions, which approximate a large infinite system by using an infinite number of a small unit cell, in order to model systems with a large number of atoms. Among all the unit cells, one cell is an original simulation box and other cells are copies, also called images, of the original simulation box. All atoms in the original simulation box are replicated throughout the space with its images to form an infinite lattice of the cells tiled together. That is, if atoms in the original simulation box have certain positions, the positions of the image atoms can be calculated according to the periodic boundary condition. As a result, each atom in the original simulation box interacts not only with other particles in the same simulation box, but also with their images in the adjacent boxes. Therefore, by using periodic boundary conditions, calculation of a large infinite system can be approximately reproduced by a less costly calculation of the small unit cell while taking into account the environmental contribution from the images. The unit cell commonly has a cubic shape, but non-cubic shapes can also be used including truncated octahedral or rhombic dodecahedral cells.

### Implementations of the EMF Methods Using Mixed Basis Sets, Exchange-Correlation Functions, and Density Fitting

A major factor in determining the cost of calculating the Fock matrix is the number of functions in the one-particle basis set for the active region and the environment region. Although a larger basis set leads to a more accurate description of the electronic structure, the description of the environment region might be adequately handled with a smaller one-particle basis set, thus reducing the total cost of evaluating the Fock matrix. Although the use of mixed basis sets is an available feature in most quantum chemistry packages, such feature is simply a special case of the more general EMF method.

In the embodiment described below, a mixed basis sets will be used to represent the active region and the environment region, in which the environment region is described using a smaller one-particle basis set. In particular, a minimal density fitting basis set is used to describe the Coulomb electrostatic repulsion term represented in equation (9).

Full evaluation of the Coulomb electrostatic repulsion energy in equation (9) is given by

$${E}_{J} = \frac{1}{2} {\sum }_{pq} {\sum }_{rs} {D}_{pq} ( pq \vert rs ) {D}_{rs} \qquad ( 11 )$$

where p, q, r, and s index one-particle basis functions,

$$( pq \vert rs ) = \int d {r}_{1} \int d {r}_{2} {η}_{p} ( {r}_{1} ) {η}_{q} ( {r}_{1} ) \frac{1}{\vert {r}_{1} - {r}_{2} \vert} {η}_{r} ( {r}_{2} ) {η}_{s} ( {r}_{2} ) \qquad ( 12 )$$

Due to the 4-index integrals (pq|rs), calculation of the above would scale theoretically as O(n⁴), where O is a big O notation in terms of computational complexity and n is the number of one-particle basis functions. In density fitting, an auxiliary basis set of basis functions χ, indexed by A and B, is used to approximate these integrals:

$${E}_{J} \approx \frac{1}{2} {\sum }_{AB} {d}_{A} {J}_{AB} {d}_{B} \qquad ( 13 )$$

where the Coulomb operator, defining the electron-electron repulsion energy is given by

$$\begin{matrix}{J}_{AB} = ( A \vert B ) = \int d {r}_{1} \int d {r}_{2} {χ}_{A} ( {r}_{1} ) \frac{1}{\vert {r}_{1} - {r}_{2} \vert} {χ}_{B} ( {r}_{2} ) & ( 14 ) \\ {d}_{A} = {\sum }_{B} {( {J}^{- 1} )}_{AB} {c}_{B} & ( 15 ) \\ {c}_{B} = {\sum }_{pq} {D}_{pq} ( pq \vert B ) & ( 16 )\end{matrix}$$

The approximate Coulomb energy is thus summed up in an expression analogous to resolution of the identity:

$${E}_{J} \approx \frac{1}{2} {\sum }_{pq} {\sum }_{rs} {\sum }_{AB} {D}_{pq} ( pq \vert {d}_{A} ) {J}_{AB}^{- 1} ( {d}_{B} \vert rs ) {D}_{rs} \qquad ( 17 )$$

In practice, calculation of the Coulomb energy with density fitting yields a computational cost that scales as O(mn²), where m is the number of density fitting basis functions. By treating the environment region with a small density fitting basis, the overall cost of the Coulomb electrostatic repulsion interaction can thus be dramatically reduced.

Next, the approximation of the exchange-correlation energy E_{xc} is described. The exchange-correlation energy E_{xc} represented in equation (9) can be described using a less-costly function (i.e. “low-level”), shown in detail as follows. For local and semi-local exchange-correlation functionals of the electron density, the exchange-correlation energy is typically evaluated via quadrature using

E_{XC}=∫dr∈[ρ(r)] (18)

where the electron density ρ(r) is calculated on a numerical grid using

$$ρ ( r ) = {\sum }_{μ v} {D}_{μ v} {η}_{μ} ( r ) {η}_{v} ( r ) \qquad ( 19 )$$

and ∈[p] is an approximate exchange-correlation functional that depends on the local density and its spatial derivatives at a given grid-point. While evaluation of the Fock matrix formally scales as O(Nn²), where N is the total number of atoms, pre-screening of the grids can be implemented easily in order to decrease the asymptotic expense. The evaluation of the non-hybrid exchange-correlation energy is a smaller computational cost than the exact exchange or Coulomb terms.

As previously described, partial inclusion of the Hartree-Fock exact exchange energy in the DFT energy has been observed to allow for substantially more accurate density functionals, commonly known as hybrid functionals. This exchange energy is written as:

$${E}_{K} = \frac{1}{2} {\sum }_{pq} {\sum }_{rs} {D}_{pr} ( pq \vert rs ) {D}_{qs} \qquad ( 20 )$$

Techniques from the Coulomb energy calculation can be applied to the exchange integrals. However, this expression includes a more computationally difficult (i.e. “high-level”) ordering of the summation indices, as the summand is not separable in terms of the density matrix. This fact makes the use of density fitting and other approximations difficult, making the usual calculation of E_{K} scale theoretically as O(n⁴). Even without using techniques like density fitting for the Coulomb energy, exact exchange is usually the most expensive component of a hybrid functional DFT calculation.

Using the EMF method, it is straightforward to describe the active region using a hybrid exchange-correlation function and the environment using a local or semi-local exchange-correlation functional. Similarly active regions can be treated using a more costly semi-local exchange-correlation functional (i.e. “high-level”) and the environment regions using a less costly semi-local exchange-correlation functional (i.e. “low-level”).

Exemplary Types of System Features from the EMF Methods

Many types of system features can be determined using the EMF methods, including total system energy, optimized geometry, and frequencies, each of which provides its own information about a molecular system.

In some embodiments, total system energy can be determined from a molecular system with a given nuclear configuration or a given set of one-particle basis functions. Total system energy can predict properties such as atomic charges, ionization energy, dipole moment, spectroscopy, electronic energy levels, and many other chemical properties. Comparisons of the total system energies of a molecular system at different states represented by different nuclear configurations or different one-particle basis functions can provide information such as bond strengths or energy changes and barriers associated with conformational changes or chemical reactions.

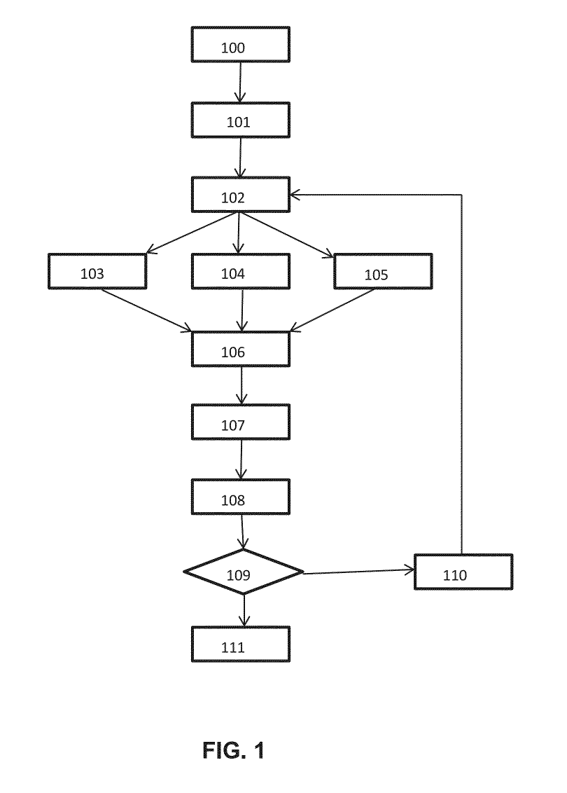

FIG. 1 provides a control-flow diagram that represents one implementation of the EMF methods and its application for determining a total energy of a molecular system. First, a set of system parameters is received for a given molecular system at a certain state to specify the molecular system to be studied (100), including geometries of the atoms in the molecular system, atomic masses, atomic connectivity, data for electrostatic properties, and other parameters familiar to a person in the skilled art. In some embodiments, the system parameters include one-particle basis functions. Then, the molecular system at the certain state is modeled within a unit cell (101) and divided into subsystems (102) within the unit cell, each subsystem treated with a chosen mean-field level of approximation, such as B3LYP, LDA, and other methods familiar to a person in the skilled art. One or more of the subsystems can be referred to as active regions in which a chemical reaction of interest can take place or where the atoms are likely to have a strong influence over the chemical reaction of interest. For cases not involving a chemical reaction, the active regions can include the atoms that are in or near a part of the molecular system that is of interest. For example, for a portion of a molecule that has several optional orientations and the desired result is a measurement/comparison of the energies of the various orientations, the part “of interest” can be the portion that has the optional orientations and, perhaps, the nearby atoms of that portion. The remaining parts of the unit cell that lie outside the active regions can be referred to as an environment region (or regions). The unit cell can be cubic, but it can also be a 3D repeating tile shape that is not cubic. The active regions are modeled using high-level mean-field approximation method (103) and the environment regions adjacent to the active regions are modeled using low-level mean-field approximation method (104). Environment regions not adjacent to the active regions can be also modeled using low-level mean-field approximation method or, alternatively, modeled with other approximation methods that has an even lower computation cost than the low-level mean-field approximation method (105), such as classical molecular mechanics. Additionally, the unit cell can be replicated and tiled in a 2D or 3D lattice to produce a larger system (106), where the influences in the unit cell modeled (107) from the replicated cells are long range effects. The total energy of the molecular system in the initial state can be computed (108) and the results recorded (109). The results calculated from the EMF methods can be compared to the results calculated from using high-level approximation on the entire given molecular system to verify the accuracy and convergence.

An embodiment of the EMF procedure shown in FIG. 1 can also include a step (110) for designing and making a product for a desired reaction. If the results determine that the initial state of the molecular system does not result in the desired energy state or desired reaction, then the nuclear configuration of the initial state is modified and a new state with a new nuclear configuration is modeled (110) and the process is repeated. If the results show that the initial state (or new state, if the process has repeated at least once) result in the desired reaction, then that modeled state is used as a blueprint to build a molecular product (111) to be utilized for the desired reaction. Optionally, multiple states can be tested in parallel. For example, a hydrogen atom can be modeled at different distances from a desired bond site of a molecule to determine a profile of energy vs. distance for the bond. In some embodiments, a different chemical group or amino acid can be selected for the new state to replace a previously selected residue.

In some embodiments, the EMF methods can be used to calculate the reaction energy of a chemical reaction. Using the deprotonation of a carboxylic acid as an example, the protonated form of the carboxylic acid represents one state, corresponding to the reactant side of the deprotonation reaction. The deprotonated form of the carboxylic acid represents another state, corresponding to the product side of the reaction, in which the chemical bond between the hydrogen and oxygen in —COOH is broken. In such case, a first and second total energy of the molecular system at two different states can be calculated, concurrently or sequentially, using the same EMF procedure described in FIG. 1, in which the first state corresponds to the reactant side of the deprotonation reaction and the second state corresponds to the product side of the chemical reaction. The difference between the two calculated total energies is defined as the deprotonation energy of the deprotonation reaction under investigation. The calculated deprotonation energy can then be used to calculate chemical quantities such as pKₐ value of the carboxylic acid. The knowledge of the pKₐ value can be subsequently used for quantitative treatment of systems involving acid-base equilibria in solution, including determining the activity and stability of proteins and enzymes, design of solutions for biochemical reactions with the knowledge of the pKₐ values of the reaction components, and characterizing the physical behavior and macro-properties, such as solubility and lipophilicity, of drug compounds in drug development processes.

Many intermediate states, including transition states, can exist in a chemical reaction between the reaction state and the product state. Accordingly, the total energies of one or more intermediate states can be calculated using the EMF methods, and plotted as a function of a reaction coordinate, which, in the above described deprotonation case, is defined as the bond length between the oxygen and hydrogen atoms of the carboxylic group.

The term “reaction coordinate” represents the changes in nuclear coordinates as the molecular system progress from an initial state to a final state, such as from reactants to products in a chemical reaction or from an initial configuration to a final configuration. In some embodiments, the reaction coordinate corresponds to the stretching or twisting of a particular bond. In some embodiments, the reaction coordinate corresponds to a bond length between one atom and its adjacent atom, an angle of rotating one bond with respect to another bond, or the distance between the center of masses of the molecular system at the initial state and the final state. In certain embodiments, the reaction coordinate represents an ensemble of the nuclear coordinates of the molecular system at each individual state. The reaction coordinate can be alternatively defined as an arbitrary parameter identifiable to a person skilled in the art.

In some embodiments, the EMF method-based electronic structure calculations can be used to perform geometry optimization to predict equilibrium geometries of molecules. The total energies calculated from the EMF methods as a function of the nuclear coordinates of the molecular system can be used to define a potential energy surface. In other words, the potential energy surface establishes the relationship between the total energy of a molecular system and its geometry. A potential energy surface can be obtained by performing an iterative steps of single point calculations using equation (9) of the description and adjusting the geometry at each step. The minima of the potential energy surface define equilibrium geometries of the molecular system corresponding to the local minimum of the estimated total energies. In addition, the maxima of the potential energy surface can be used to determine the energy and geometry of the highest energy states such as transition states. The gradient vector of first order derivative of the potential energy surface with respect to nuclear coordinates can be used for the calculation of force. The second order derivative of the potential energy surface is typically called a Hessian matrix that can be used in geometry optimization to locate potential energy minima, transition states and other stationary points such as saddle points. The term “stationary points” refers to configurations of the molecular system wherein the first order of derivative of the total energy is zero.

In some embodiments, frequencies can be obtained from computing various modes of nuclear vibrational motion within a molecule based on the second order derivative of the potential energy. Such calculations can be used to determine zero-point and thermal corrections to the internal energy, enthalpy contribution to Gibbs free energies, and vibrational spectra of a molecular system.

In some embodiments, differentiation of the potential energy and electron density with respect to external fields can be used to calculate response properties. Energy derivatives with respect to applied electric fields correspond to electric moments, infrared intensities, polarizabilities and hyperpolarizabilities and energy derivatives with respect to external and nuclear magnetic fields correspond to magnetic properties such as magnetic moment, magnetic susceptibilities, and nuclear magnetic resonance chemical shifts.

In some embodiments, the EMF methods herein described are implemented in combination with many other simulation tools identifiable by a skilled person upon reading of the present disclosure. The simulations tools that can be used in combination with the EMF methods include any classical or quantum molecular simulation tool that utilizes Born-Oppenheimer potential energy surfaces, including molecular dynamics, Monte Carlo simulation, energy minimization and docking. Such implementations will involve evaluating the total energy of the system under consideration and its derivatives with respect to parameters in the Hamiltonian.

In some embodiments, the EMF methods are combined with other simulation methods to determine kinetic and thermodynamic properties of a molecular system by sampling configuration space according to Boltzmann distribution. Such samples can be obtained by molecular dynamics that simulates the thermal motion of the molecular system by integrating the equations of motion. Alternatively, such samples can be obtained by Monte Carlo methods by randomly stepping through conformation space and using the Metropolis criterion to ensure the convergence of the conformational sampling. Such kinetic and thermodynamic properties include enthalpy and entropy of the molecular system, Gibbs free energy, heat of reaction, activation energy, rate constant, and many other properties of the molecular system identifiable by a person skilled in the art.

The EMF methods can also be used in combination with other multi-scale strategies identifiable by a skilled person upon reading of the present disclosure. As one example, the EMF methods can be embedded in a molecular mechanics or continuum description of a larger environment. Alternatively, more accurate wavefunction-based methods can be embedded, by using the above-described projector technique, in a multi-level EMF description of the environment.

### General Areas of Application

The term, “system features” refers to features of a molecular system and particles contained in the molecular system that are derived from the total energy of the molecular system and density matrix of the molecular system. Exemplary system features comprise location of the particles, related geometries, interactions between particles and related bonds, stability of the system. In addition to system features that can be extracted from the ground-state potential energy surfaces, response of the electronic density to external fields can be used to obtain excited-state potential energy surfaces. Exemplary system features can additionally include response properties that characterize the response of the total energy and density matrix to external fields such as magnetic field and electric field.

System features define the chemical reactivity and/or physicochemical state of the system or portions thereof “Chemical reactivity” refers to the relative capacity of an atom, molecule, or radical to undergo a chemical reaction with another atom, molecule, or compound. In particular, chemical reactivity can be detected and/or expressed as the rate at which a chemical substance tends to undergo a chemical reaction in time. For example, in some systems the rate constant of a chemical reaction can be determined by K=A*e^{-Ea/RT}, in which Eₐ is the activation energy of the chemical reaction A reaction rate of a chemical reaction can be determined from the rate constant and concentrations of the reactants in the chemical reaction. Other factors can also influence the reaction rate, including temperature and catalysts.

In some pure compounds, reactivity is connected and in particular regulates by the physicochemical state of the system.

The term “physicochemical state” refers to macroscopic, atomic, subatomic, and particulate combination of features of a molecular system that define a state of the molecular system and the related propensity to undergo physicochemical transformations or evolutions. Exemplary combination of features that define the physicochemical state of a molecular system comprise: intermolecular forces that act upon the physical properties of materials (plasticity, tensile strength, surface tension in liquids); the identity of ions and the electrical conductivity of materials; interaction of one body with another in terms of quantities of heat and work; number of phases; number of components; and degree of freedom (or variance).

In particular, chemical reactivity, physicochemical state, and related properties are derived from the system features and/or the energy of the molecular system as would be understood by a skilled person.

Accordingly, the EMF method allows in several embodiments to predict and/or control chemical reactions and/or physicochemical features of a molecular systems or portions thereof. For example, reagents of a chemical reaction can be selected to obtain formation or breaking of a covalent, ionic or other kind of bond. Also, reagents or reaction conditions can be selected to obtain the transition of a compound from one state to another state. As an additional example, interactions between a compound and a light source can be controlled to obtain a certain absorbance of light by the compound or portions thereof (detectable for example by a change of a rotational, vibrational or nuclear magnetic resonance spectra of the system). Also, a compound can be designed to have a desired stability and/or a desired reactivity alone or in combination with another compound or portions thereof (e.g. an enzyme designed to obtain a certain reaction or a ligand and/or receptor designed to obtain a desired ligand receptor interactions (e.g. agonist, antagonist or superagonists).

Alternatively, the EMF methods allow in some embodiments to calculate the effect of an external field on UV-visible, fluorescent, vibrational, rotational or nuclear magnetic resonance spectra of a molecular system. For example, by varying the external electric field in the EMF calculations, the impact of the external electric field in the electric double layer on an oxygen reduction reaction on an electrode can be estimated. Furthermore, the methods can be applied to calculate the effect of such external electric field in the electric double layer on possible changes in adsorption energies, reaction barriers and reaction mechanisms for the oxygen reduction reaction on different metals.

The currently disclosed EMF methods and various implementations can be used to study chemically reactive systems and non-adiabatic systems. General areas of application include: heterogenous catalysis, homogenous catalysis such as splitting of ligands, semiconductor etching, processes at semiconductor surfaces, chemistry on and among nanoparticles, chemistry at battery electrodes, graphene chemistry, biocatalysis, and many other application domains where chemical reactions are involved. Application domains of the EMF methods are further illustrated in the following sections, which are provided by way of illustrating exemplary uses of the EMF methods and are not intended to be limiting.

In particular, the EMF methods can be applied to systems involving strong inter-atomic bonding, such as conjugated systems. The term “conjugated system” used herein is a system of connected p-orbitals with delocalized electrons. Small errors in modeling of such complex systems can result in inappropriate results. Studies of these systems can be conducted based on high-level ab initio quantum mechanics theories, but the complexity and the number of variables of such systems that must be taken into account carries a high computational cost. Therefore, conventional methods developed for non-conjugated systems usually experience difficulties in this regard. Similarly, systems such as metallic, semiconductor, and nanoparticle systems that have delocalized electrons have many of the same challenges. The currently disclosed EMF methodology has shown success with improved results in reducing the errors to acceptable levels, in many cases, to reduced errors less than 1 kcal/mol in terms of the relative energy as shown in the above exemplary applications. The computational cost of the EMF methods is also comparable to many low-level theories.

### Exemplary Applications of the General EMF Methods

The EMF methods presented above have been implemented in the special case of embedding one DFT approximation in another. To provide a proof of principle of the proposed EMF methodology, a series of applications of this implementation has been performed.

### 1. Deprotonation of Methanol

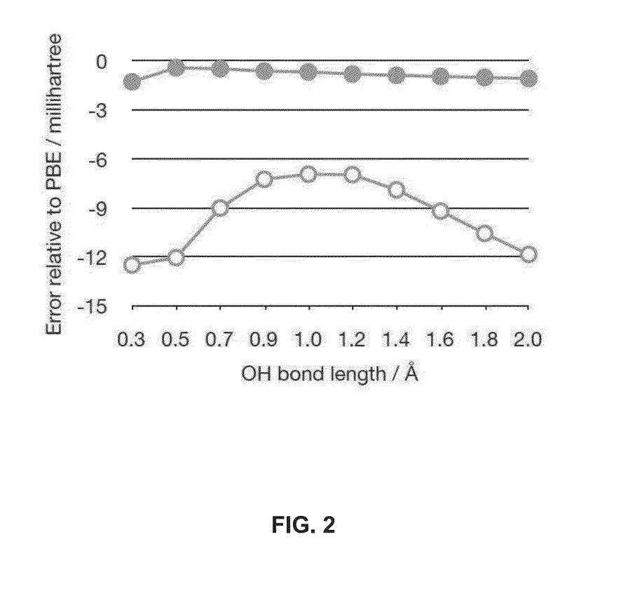

Potential energy curves for removing a proton from the methanol molecule were calculated. The reference calculation used the PBE exchange-correlation functional, and the atomic orbital basis set aug-cc-pVDZ are used on oxygen and cc-pVDZ on other atoms. FIG. 2 shows a comparison of the error relative to PBE of a simple LDA and of an EMF calculation in which the AOs on the —OH moiety are treated using PBE and on the remainder using LDA. It can be seen that, even in this simple example, EMF transforms the accuracy of the simple low-level treatment, bringing agreement with PBE within chemical accuracy.

2. Symmetric S_{N}2 Reaction of F— with n-Propyl Fluoride

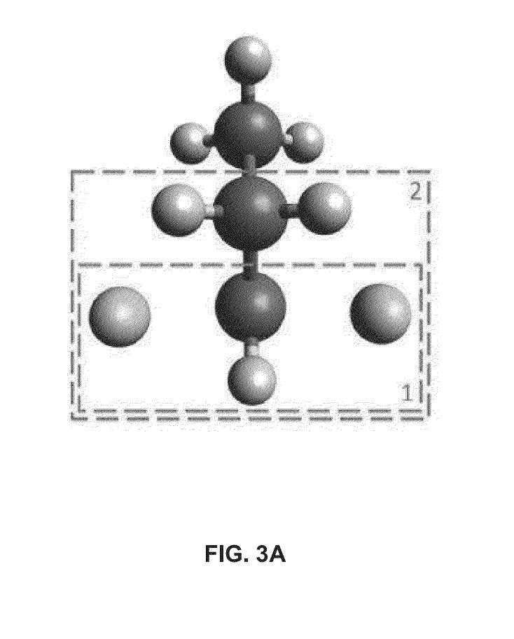

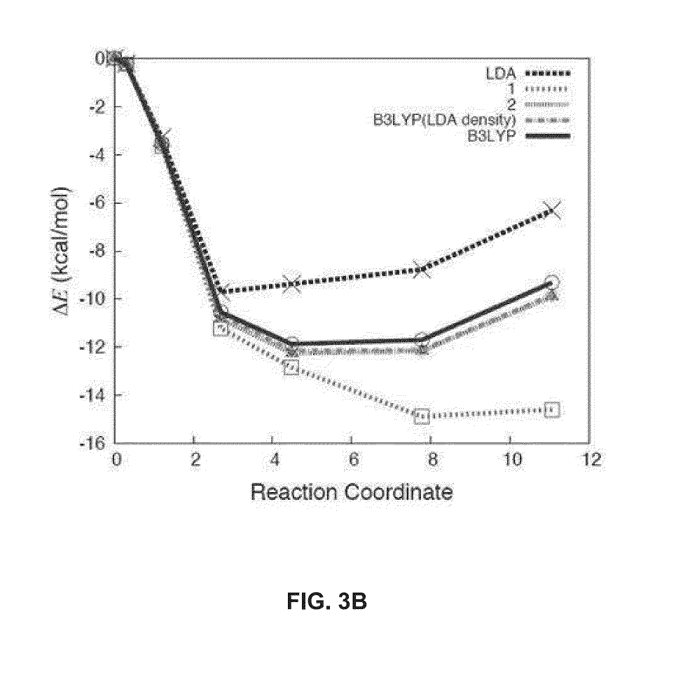

The EMF method is demonstrated, in FIGS. 3A-3B, in the context of the symmetric S_{N}2 reaction of F— with n-propyl fluoride. FIG. 3A shows the structure of the system in the transition state region for the reaction with two examples of active regions shown. FIG. 3B presents the energy of configurations of the system along its reaction pathway, computed with respect to the transition state (TS) energy at various levels of approximation, including the two active regions under EMF method. The reference calculation used the B3LYP exchange-correlation functional (open circles), and a comparison is shown for these results with the lower-quality LDA exchange-correlation functional (crosses). Note that the LDA functional introduces errors of approximately 4 kcal/mol, nearly doubling the estimate of the reaction barrier height from the B3LYP functional.

The EMF calculations employ two active spaces, as is illustrated in FIG. 3A. For the high-level description of the active region, the EMF calculations use the B3LYP functional; for the low-level description of the environment, the calculations use the LDA functional. For the results of EMF with active region 1 (open squares), which involves only the atoms that are directly participating in the reaction, the EMF results exhibits errors that are larger than the LDA calculations. However, for the results of EMF with active region 2 (triangles), in which includes an additional —CH2 from carbon chain, the EMF results appear to be in excellent agreement with the B3LYP reference results. With only a very small number of atoms in the active region, the multi-level description provided by EMF converges relatively rapidly to reference calculations performed over the full system.

For the purpose of analysis, FIG. 3B also includes data in which the B3LYP energy is evaluated over the density for the system obtained using LDA (open diamonds). These results also appear to be in agreement with the reference B3LYP results and they appear to be graphically indistinguishable from the EMF results obtained with active region 2. The agreement of these results indicates that, although a low level of mean field approximation, such as LDA, tends to provide a sub-par description of energies, it can provide a satisfactory description of system densities and embedding potentials. Such fact leads to the widespread success of multi-level partitioning via the embedded DFT framework [reference 38].

### 3. Exchange Reactions in Both Alkane and Alkene Systems

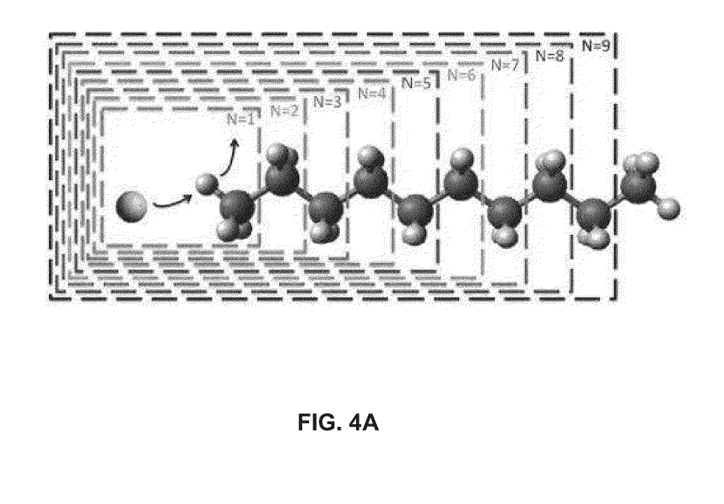

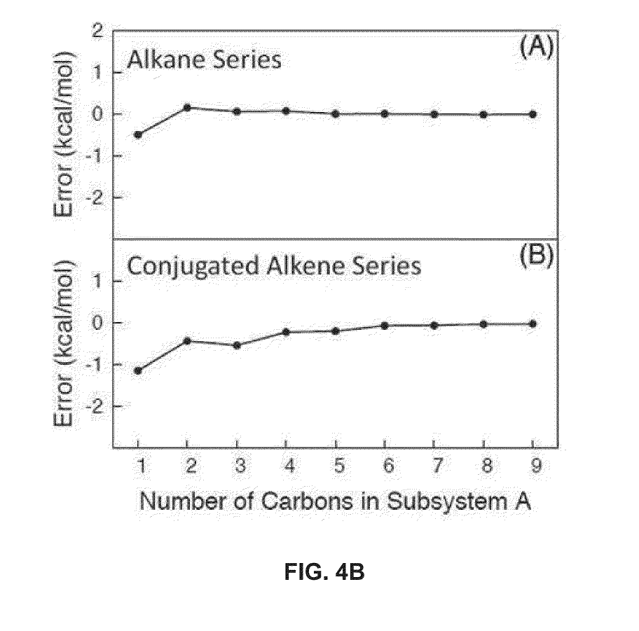

The convergence of the EMF method is herein systematically demonstrated in both non-conjugated and conjugated systems. FIG. 4B presents the error in B3LYP-in-LDA embedding using the EMF scheme as a function of the number of carbons included in active region for the exchange of fluoride to a hydride in both an unconjugated alkane systems (1-fluorodecane) and a conjugated alkene system (1-fluoro-1,3,5,7,9-decapentaene, shown in FIG. 4A with nine examples of active regions shown in number of carbons in Subsystem A, aka the active region). All errors are computed relative to reference B3LYP calculations. In both systems, the results for LDA performed in over the full system are in error by approximately 10 kcal/mol with respect to the reference B3LYP result.

From panel A in FIG. 4B, it is shown that with only two carbon atoms in the alkane chain, the EMF result is essentially fully converged to the reference. For the conjugated alkene system, the errors in the EMF results are similarly small and also converged with inclusion of only a small number of carbon atoms in the chain. In both cases, the result converged smoothly and rapidly with respect to system size, yielding negligible errors that vanish on the scale chemical accuracy. This behavior observed in a conjugated system indicates that for many of the complex applications (such as fullerene systems, or metal surfaces) the EMF method is applicable.

### 4. Torsional Barrier of Bibenzyl

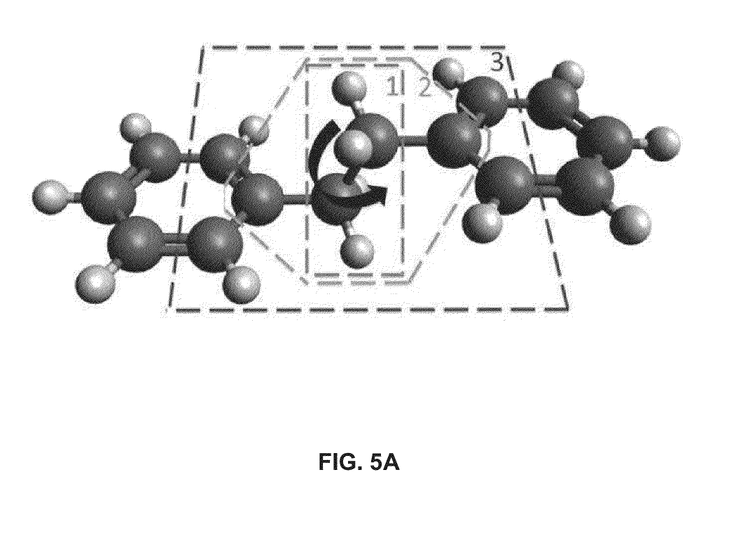

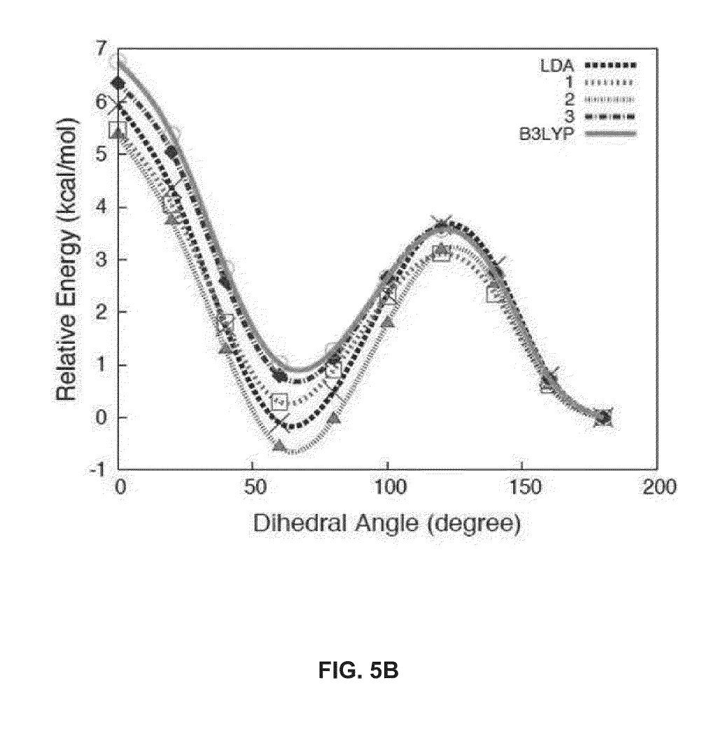

In this implementation, an additional application of the EMF method to a conjugated system is demonstrated, and its convergence with respect to the size of the embedded subsystem is illustrated. FIG. 5B presents the results of EMF calculations for the torsional energy profile for the bibenzyl molecule. The torsional rotation is associated with internal rotation, as indicated in FIG. 5A. The reference calculation used the B3LYP exchange-correlation functional (open circles), and these results are compared with the lower-quality LDA exchange-correlation functional (crosses). Note that the LDA function introduces errors that exceed 1 kcal/mol (approximately 25% of the reference barrier height), and it also incorrectly predicts the minimum-energy conformation of the system.

The EMF calculations employ three active spaces of increasing size, as is illustrated on FIG. 5A. For the high-level description of the active region, the EMF calculations use the B3LYP functional; for the low-level description of the environment, the calculations use the LDA functional. For the results of EMF with active region 1 (open squares), which involves no atoms in the conjugated system, the EMF results are mildly improved in comparison to the LDA results. However, for the results of EMF with active region 2 (triangles), in which only one atom from each benzene ring is included in the active region, the errors increase. Such increase in error reflects the fact that this choice of active region now involves partitioning across a conjugated system. Finally, for the results of EMF with active region 3 (diamond), in which a larger fraction of each benzene ring is included in the active region, the EMF results yield extremely good agreement with the B3LYP reference. These results again indicate that EMF allows for accurate embedding in conjugated systems, even if only a few atoms of the conjugated system are included in the active region. Furthermore, these results emphasize that EMF converges systematically to the reference results as the size of the active region increases.

### Exemplary Applications of the EMF Methods Using Mixed Basis Sets, Exchange Correlation Functions and Density Fitting

The accuracy of various EMF implementations is illustrated across various chemical reactions, illustrating effects of using (KS-DFT)-in-(KS-DFT) (or more succinctly DFT-in-DFT) embedding with various combinations of mixed one-particle basis set for the active and environmental regions, mixed exchange correlation functions for different regions, and mixed density fitting basis sets for the Coulomb interaction calculations associated with the different regions. The CPU time per SCF iteration measured on an Intel Xeon 2.6 GHz processor for the different embedding schemes is also discussed. Furthermore, the comparison between DFT-in-DFT and other embedding schemes, such as vacuum embedding, ONIOM (QM:MM), and ONIOM(QM:QM), is shown.

In the following sections, mixed basis sets were used to denote 6-31G*/STO-3G, mixed exchange correlation to denote PBE/LDA, mixed density fitting to denote Ahlrichs/Spherical, ONIOM(QM:MM) to denote ONIOM(PBE/6-31G*:UFF), and ONIOM(QM:QM) to denote ONIOM(PBE/6-31G*:LDA/STO-3G).

### 1. Boundary Across a Single Bond in Alkane: S_{N} 2 Reaction.

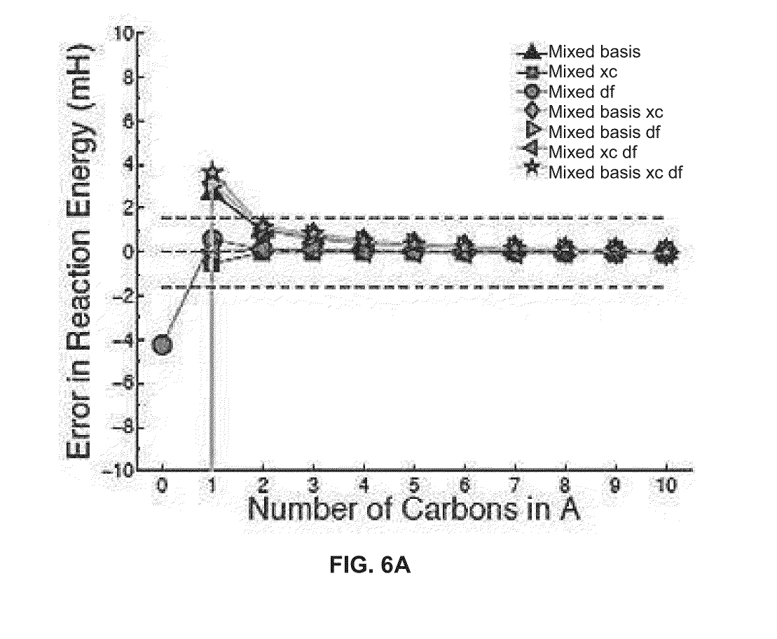

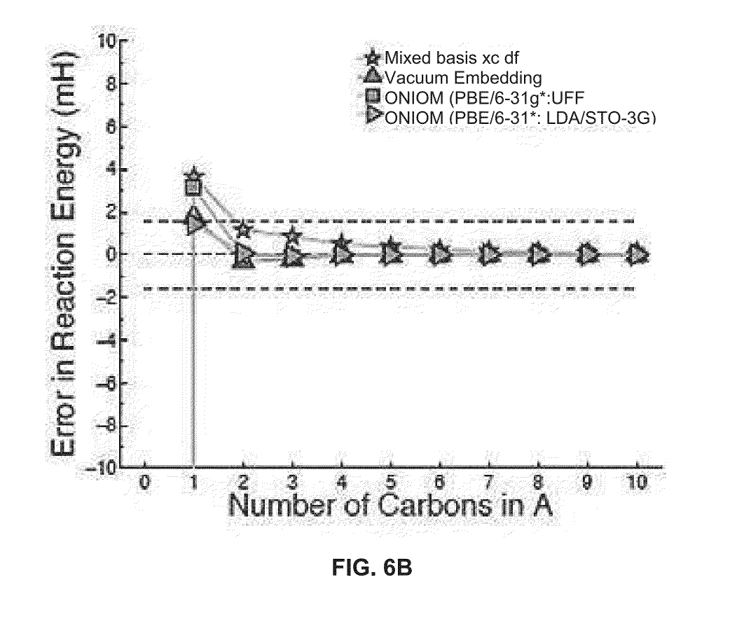

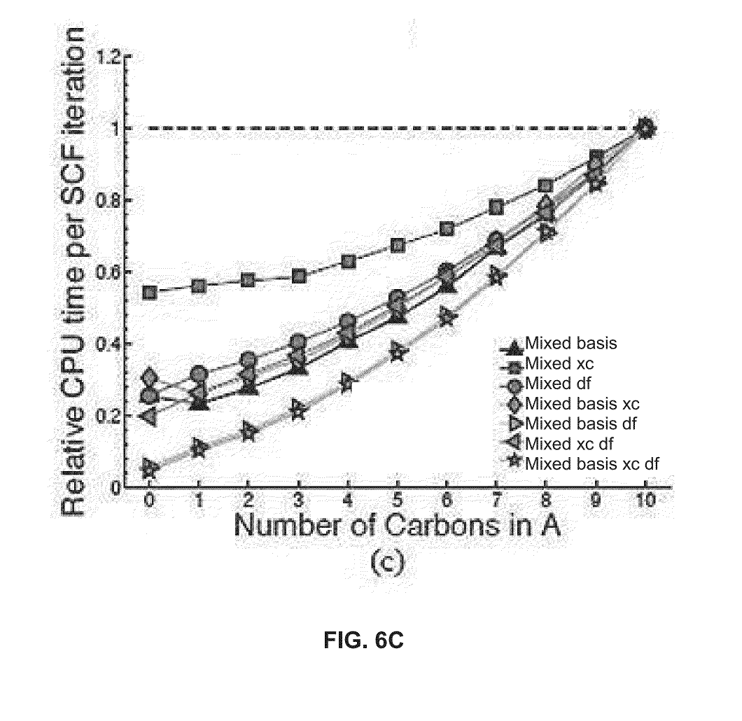

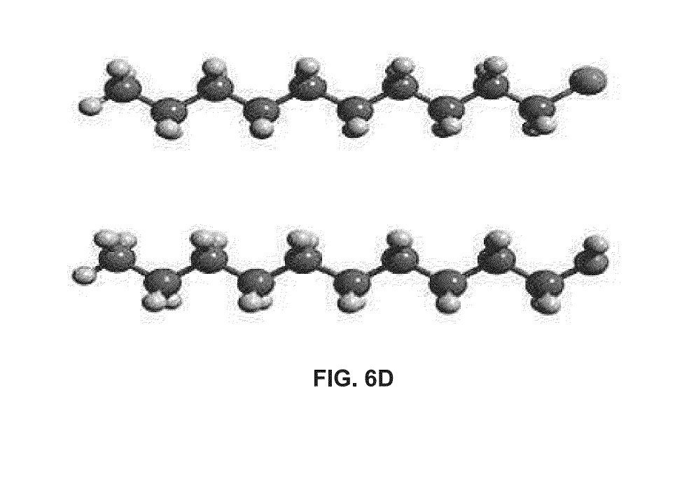

A system consisting of only single bonds is particularly easy to treat with conventional embedding schemes including ONIOM. This is largely because the reaction center is so localized that the rest of system does not play a crucial role in the reaction. DFT-in-DFT and other embedding methods were tested to calculate the reaction energy of SN 2 reaction from haloalkane to alcohol (shown in FIG. 6D, top to bottom). As shown in FIG. 6A, any DFT-in-DFT scheme performs well. After N=2, the error for any of them is ranged within 1 kcal/mol. It should be noted that the N=0 corresponds to the low-level calculation. Compared to ONIOM and vacuum embedding, as in FIG. 6B, the error of the lowest level DFT-in-DFT with mixed basis sets, exchange correlation functions, and/or density fitting converges as quickly as the others do. Moreover, the lowest level DFT-in-DFT at N=2 can save 80% of CPU time per SCF iteration compared to full DFT with the reasonable accuracy, as shown in FIG. 5C. It is expected that this cost saving will be even more significant in larger systems because the scaling is not linear.

### 2. Boundary Across a Single Bond in Conjugation: Conjugated Alkene

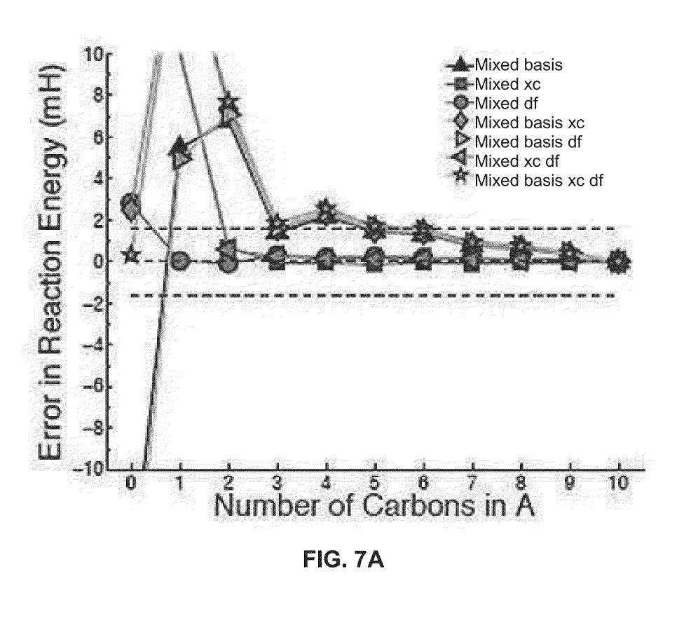

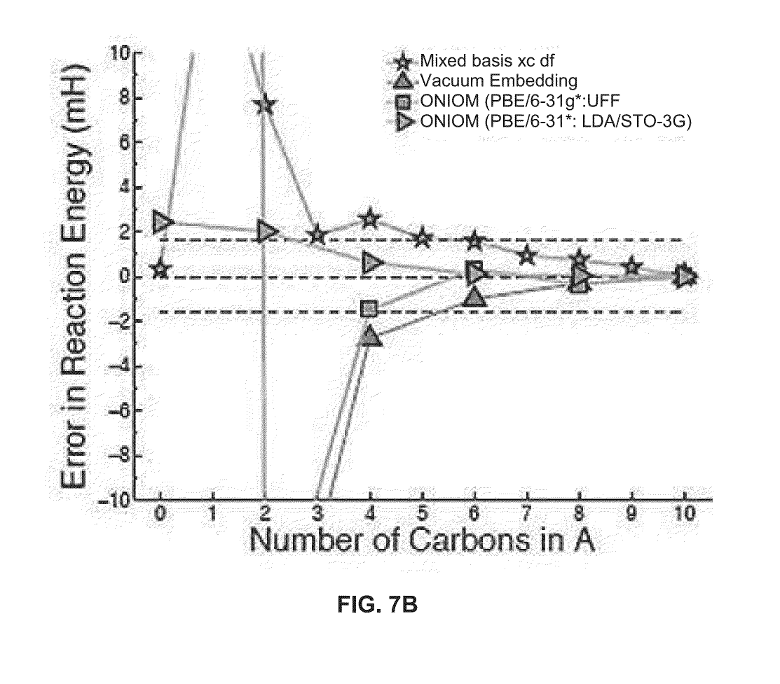

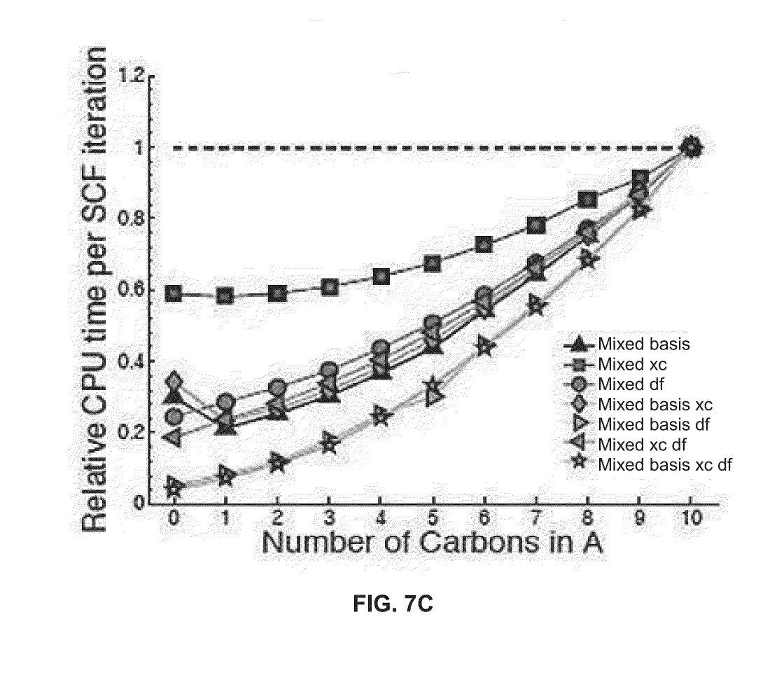

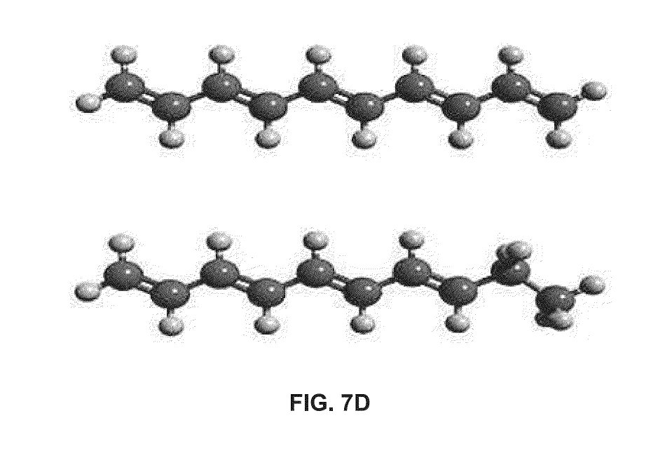

A conjugated linear alkene could be challenging for ONIOM because the distinction between single and double bonds becomes slightly unclear. However, if the reaction still occurs quite locally, e.g. at the terminal carbon of the chain, ONIOM may perform well. The hydrogenation at the terminal carbons of conjugated alkene belongs to such cases, as shown in FIG. 7D (top, alkene; bottom hydrogenated alkene). In FIG. 7A, one can notice that the error from using coarse-grained density fitting functions is tiny compared to others. Moreover, the largest error at the first few points (N=0, 1) comes from mixing exchange correlation functions, but the error is dominated by mixing basis sets in the rest of data. Using mixed basis sets introduces a spurious dipole at the boundary between two subsystems, and in some cases this is the cause of slow convergence with respect to the size of active subsystems. FIG. 7B shows that all of the results are within 1 kcal/mol after N=6. It should also be noted that the odd number points are not plotted for ONIOM because these points cross a double bond. In principle, one could still perform those calculations, but this is still a violation of ONIOM rule that restricts double or triple bond crossing. The lowest level DFT-in-DFT saves more than 50% of CPU time per SCF iteration compared to full DFT at N=6, as shown in FIG. 7C.

### 3. Boundary Across Two Single Bonds in Conjugation: Diels-Alder Reaction

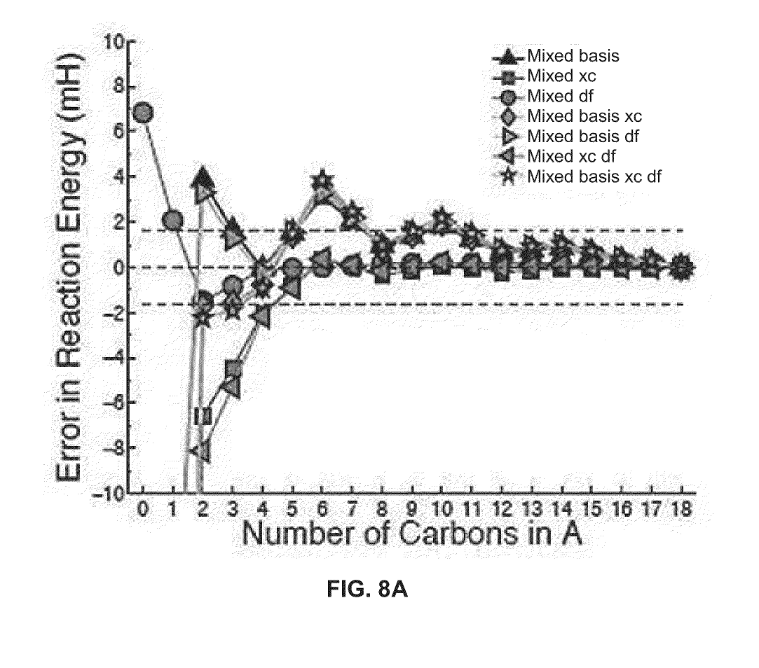

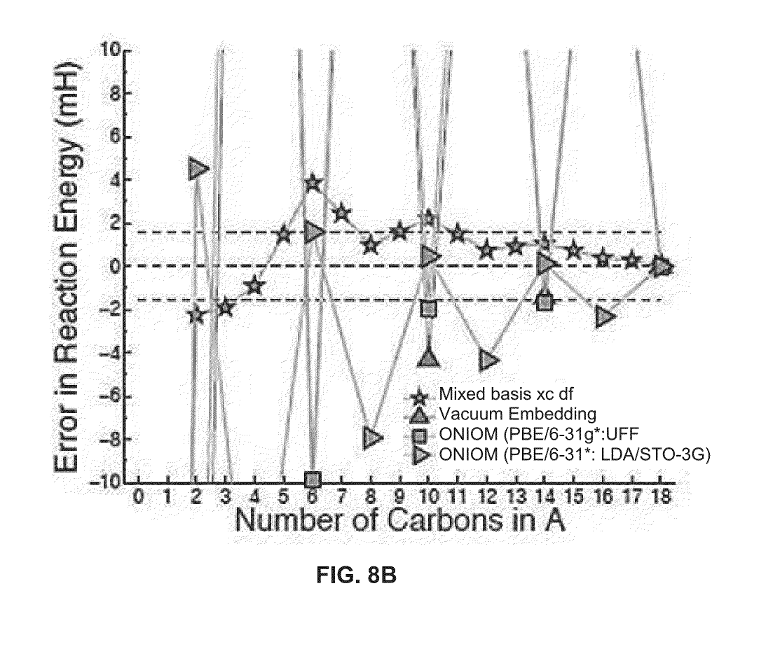

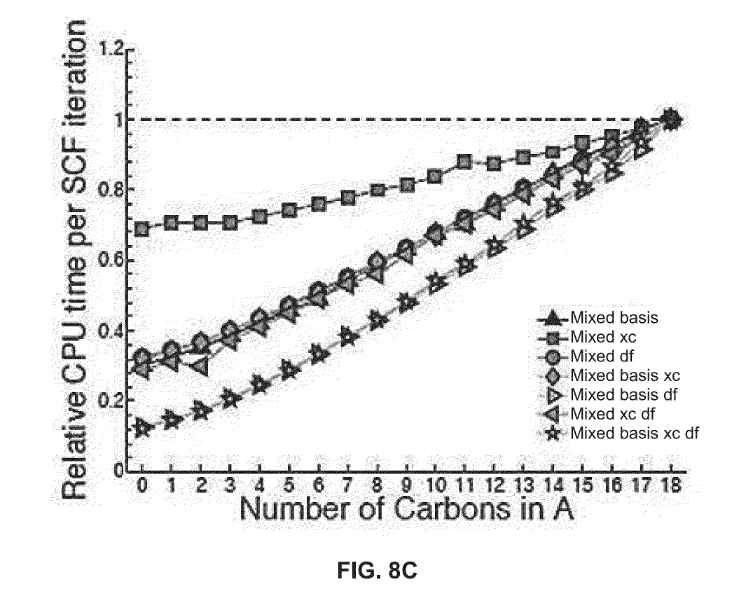

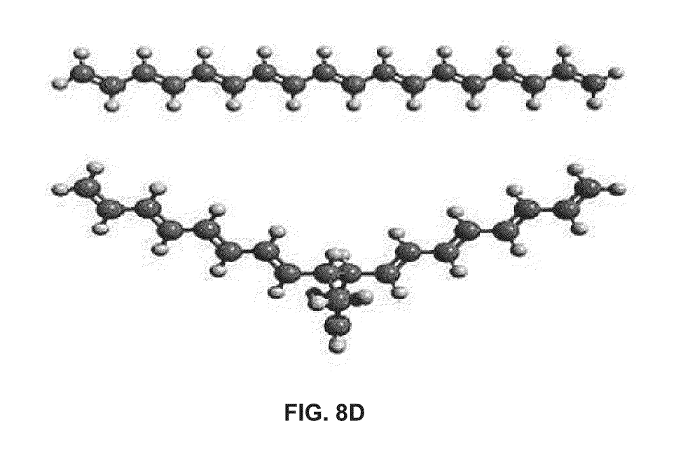

If a reaction occurs at two carbons in the internal of a linear alkene, there are two interfaces between subsystems. Although the reaction still would occur quite locally, it is a harder case to use embedding methods compared to the previous case. As an example, a Diels-Alder reaction between a conjugated linear alkene chain and 1,3-butadiene is illustrated, as shown in FIG. 8D (top, alkene chain; bottom product). In FIG. 8A, it is found that after N=10 all of the different embedding schemes perform within the error of 1 kcal/mol. In this case, N=0 does not correspond to the low-level calculation because 1,3-butadiene have been included in the high-level calculation. Thus, the low-level calculation result would be at N=−4 if it were included. Similarly to the previous case, the slow convergence arises from using mixed basis sets (diamonds shown in FIG. 8A). FIG. 8B shows that vacuum embedding and ONIOM (QM:MM) do not appear to converge at all, while ONIOM (QM:QM) converges normally, and the lowest level DFT-in-DFT converges at the lowest number of carbons. FIG. 8C shows the computational cost saving in relation to the size of the active region for different methods.

### 4. Boundary Across Single and Double Bonds in an Aromatic System: Hydrogenation of Naphthalene

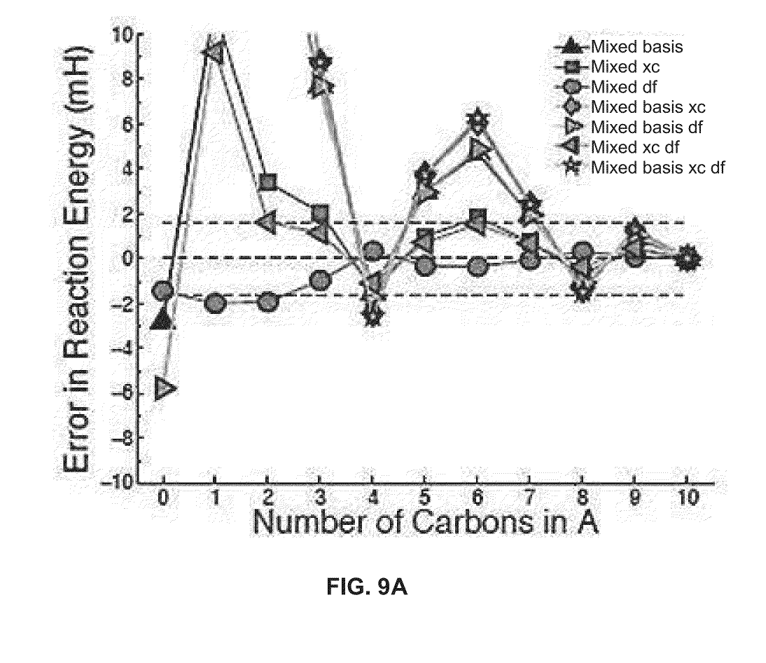

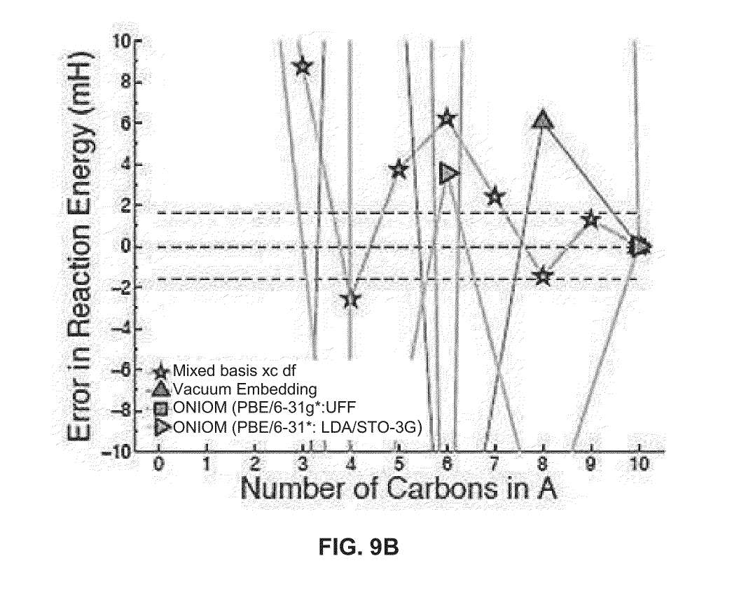

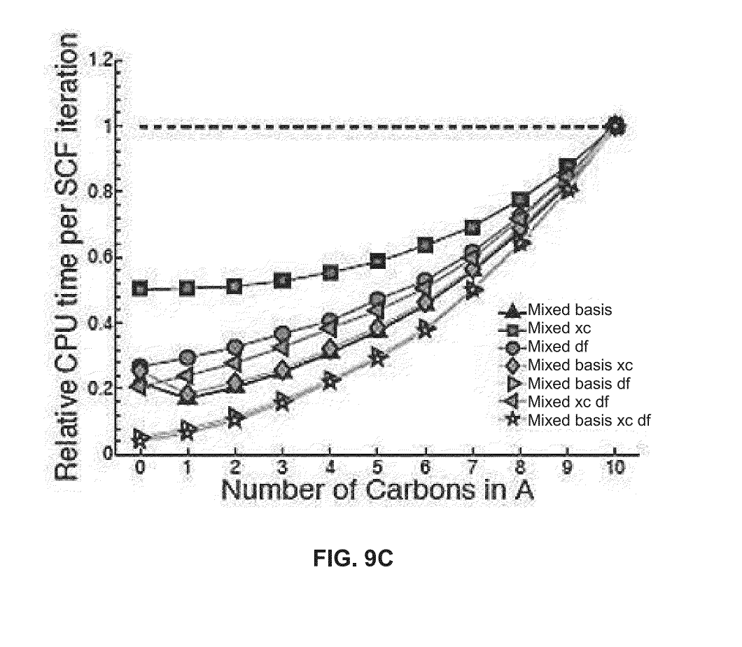

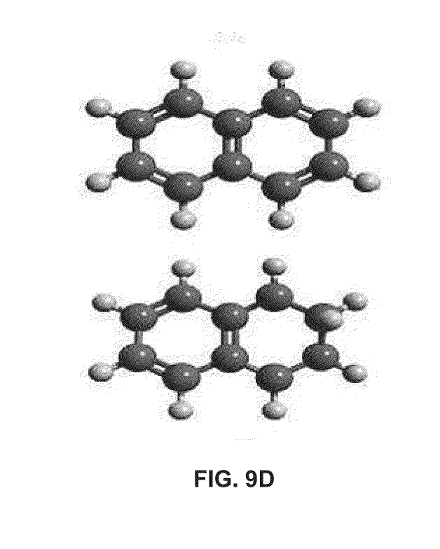

In naphthalene, or generally in aromatic systems, there is no clear distinction between single and double bonds. In this regard, ONIOM is expected to fail in capturing correct chemistry in such systems. On the other hand, DFT-in-DFT does not require any a priori assumption on chemical bonds, so it should be able to describe proper chemistry with reasonable accuracy. To demonstrate this point, the different embedding methods to evaluate the reaction energy of naphthalene hydrogenation, as shown in FIG. 9D (top, naphthalene; bottom, hydrogenated naphthalene) can be tested. As described in FIG. 9B, the lowest level DFT-in-DFT does not show a monotonic convergence, but the results at N=8, 9 are still within 1 kcal/mol. Unlike the lowest level DFT-in-DFT, ONIOM (QM:QM) does not have any point within the 1 kcal/mol range. In fact, only one point is within 10 mH. The vacuum embedding and ONIOM (QM:MM) show the plotted error is larger. The cost saving in this particular case, as shown in FIG. 9C, is not huge because the fully system is relatively small; larger speedups will accompany situations in which the environment region is much bigger than the active region.

### 5. Manifestation of Charge: Deprotonation of Carboxylic Acid

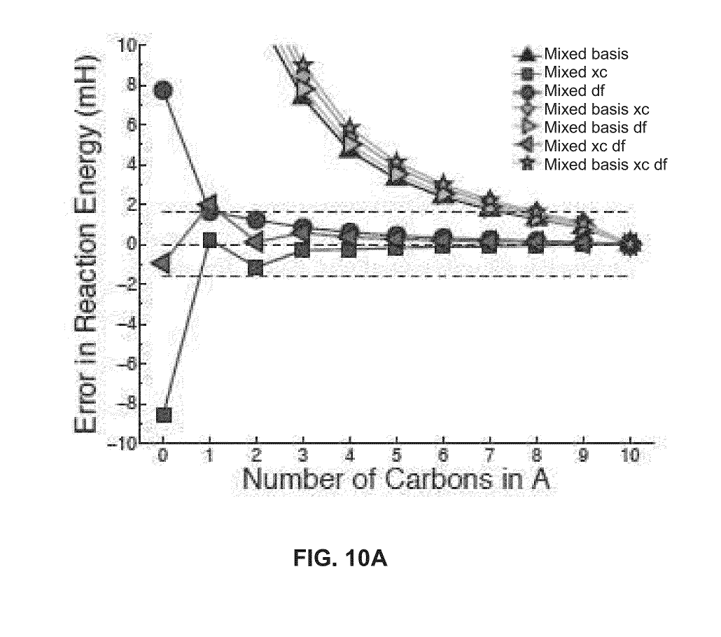

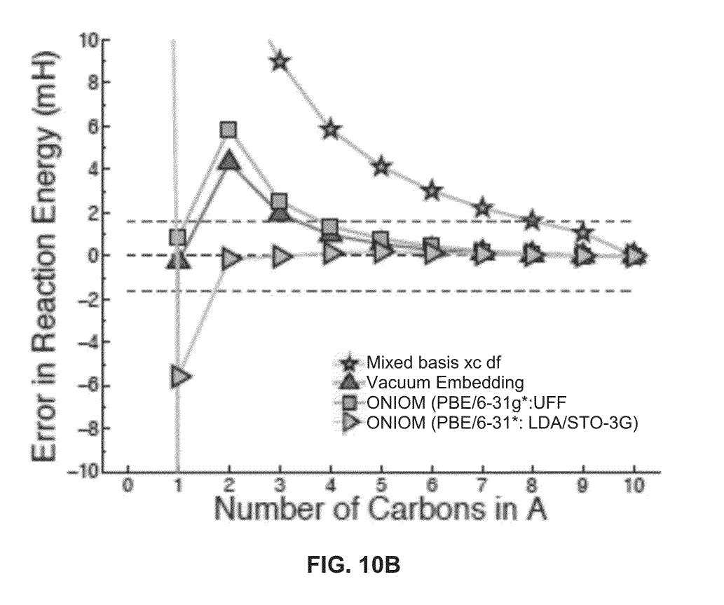

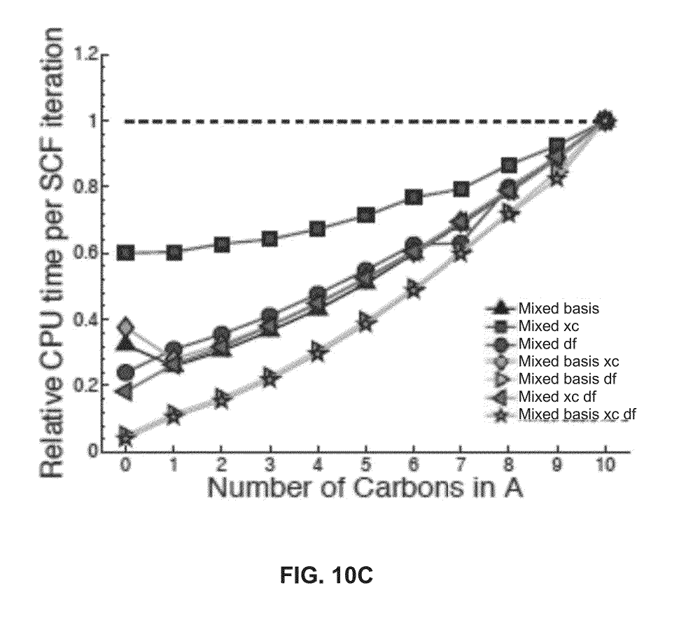

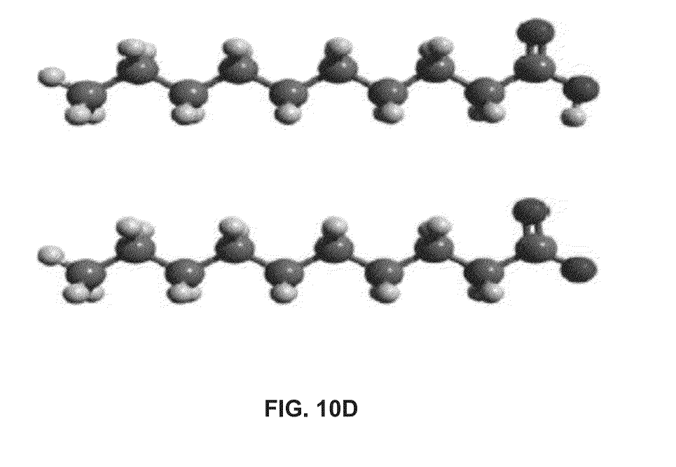

DFT-in-DFT may behave less well in some types of reactions. As mentioned earlier, mixing basis introduces a spurious dipole across the boundary between subsystems, and it can cause a slow convergence in the reaction energy as the size of active subsystem increases. If the reaction manifests charge changes in system, e.g. deprotonation or protonation, the spurious dipole would affect the results even more significantly. As the first example to illustrate this point, the deprotonation energy of carboxylic acid, as shown in FIG. 10D (top, carboxylic acid; bottom, deprotonated carboxylic acid) is discussed below. As shown in FIG. 10A, any scheme that includes mixing basis sets shows a significantly slower convergence compared to others. Since the reaction is a simple chemical reaction and there is a clear distinction between single and double bonds, ONIOM and vacuum embedding perform well as shown in FIG. 10B. In this case, one could use a mixed exchange-correlation, density-functional theory instead of a low level approximation, at the expense of cost saving, as shown in FIG. 10C.

### Exemplary Future Applications

### 1. Reactions on Semiconductor Nanocrystals

Reactions on semiconductor nanocrystals are one of the many application domains that can be investigated using the EMF methods. Ligand-binding reactions on semiconductor nanocrystals provide an important class of targets for the development of efficient photovoltaic materials. In particular, cadmium selenide (CdSe) quantum dots have been extensively characterized both theoretically [references 40-44] and experimentally [references 40, 45, 46], with focus on issues that range from the dependence of material and photochemical properties on cluster size, stoichiometry, and ligand coverage. The disclosed EMF methods can be applied to model acetate and methylamine capped CdSe quantum dots, with focus on ligand binding and exchange energies, as well as cluster stability [reference 40]. Results can involve the description of chemical processes that involve breaking covalent bonds in the presence of an extended semiconductor material.

### 2. Inorganic Catalysts and Transition Metal Complexes

Transition metal complexes in the area of inorganic catalysis are another application domain. High-level approximation methods such as KS-DFT have been used for the characterization of structures and energetics in this area, due to their adequate description of the electronic structure. However, the cost of high-level approximation methods such as KS-DFT calculations for such systems is still too computationally high to enable MD simulations, trajectory-based reaction mechanism studies, and inclusion of explicit solvent. The disclosed EMF methods can be employed in such systems to overcome the above mentioned drawbacks while still being able to maintain or exceed the accuracy.

Inorganic catalysts, such as Cobalt- and Nickel-based catalysts, have emerged as promising candidates for hydrogen evolution in solar powered water-splitting devices [reference 47]. The formation of metal-hydride intermediates [references 48, 49] is an important step in the catalytic processes. Recent studies have focused on the use of KS-DFT calculations and ONIOM calculations for the description of such systems, revealing that the multi-level partitioning description of the ONIOM method provides inadequate accuracy, even for qualitative trends [references 50, 51]. The EMF methods can be employed to compute the hydride dissociation energy for Cobalt- and Nickel-based catalysts, such as the Co(III)H(dpgBF₂)₂L₂ (dpg=diphenylglyoxime, L=acetonitrile) system.

Another focus of transition metal catalysis is to develop systems for efficient oxygen evolution [reference 52]. Experimental work has demonstrated water oxidation catalysis by a di-nuclear Ru complex [reference 53], and a subsequent KS-DFT study of deprotonation and redox chemistry [reference 54] examined a set of corresponding Ru monomers across a broad range of pH-pE values, yielding insight into the effects from ligand field couplings and metal-ligand charge transfer. The EMF method can be employed to compute ligand acidities, reduction potentials, solvation energies, and free energy changes with respect to Ru spin state for systems such as the Ru(OH)(Q)(tpy) (Q=3,5-di-tert-butyl-1,2-benzoquinone, tpy=2,2:6,2-terpyridine) system.

### 3. Fullerene Systems

Another application domain of the EMF methods is the redox potential study of molecules encased in fullerene systems that involve additional complexities exhibiting extensive conjugating and multiple oxidation states. Metal nitride clusterfullerenes (NCFs) are a new and expanding class of endohedral fullerenes in which a homogeneous or heterogeneous metal nitride cluster is enclosed inside a large carbon cage [reference 55]. Experimental work in this system indicates that upon reduction or oxidation of the metal nitride cluster, the excess charge can localize either on the cluster itself, or can cascade to the surrounding fullerene [references 56, 57]. The EMF methods disclosed herein can be employed to calculate the system oxidation and reduction potentials [reference 56],

### 4. MOF-74 Hydrocarbon Separation

Fe-MOF-74 is an iron-containing metal-organic framework useful for efficiently separating short chain hydrocarbon (C1-C3) molecules based primarily on their degree of saturation [references 58, 59]. Due to the prohibitively large size of the MOF unit cell, previous KS-DFT studies [reference 60] have reduced the system to intermediate representative clusters consisting of 50-100 atoms, in order to calculate hydrocarbon binding energies with respect to the hydrocarbon identity and the Fe spin state. The currently disclosed EMF methods can be employed to study a more realistic representation of the system consisting of an increased number of atoms. Results can provide further indications on how hydrocarbons bind to metal atoms and other subtle effects from structural distortion, charge transfer, and ligand field effects. Additionally, EMF calculations can be performed with periodic boundary conditions to investigate the sensitivity of the calculated results to approximations associated using the finite cluster representation.

### 5. High Energy Density Materials (HEDM)

The refinement of explosives such as Research Department Formula X (RDX), HMX, and TNAX is a subject of interest for a variety of industrial and military applications [references 61-63]. The energy density, cost, and environmental toxicity [reference 64] are key features of HEDM. Other critical properties include their stability against thermal impulses and impact shocks, which determines the safety and practicality with which the materials can be transported and stored [reference 65].

Understanding and improving the stability of HEDM requires investigation of the early-stages of chemical decomposition and explosion, but high-resolution condensed phase experiments [references 66, 67] remain a technically challenging and potentially hazardous pursuit. Reliable, simulation-based approaches for studying and predicting explosive initiation dynamics are thus attractive from the perspective of both cost and safety, although the complex chemistry and long timescales of HEDM decomposition create significant methodological challenges. Empirical descriptions [references 68-71], including ReaxFF methods and tight-binding methods such as DFT binding (DFTB), and first-principles methods such as KS-DFT can be used to computationally study such systems. However, the ReaxFF methods [references 70-72] are limited by their lack of generality and requirement for extensive parameterization, the tight-binding methods [references 73-78] do not offer the accuracy of first-principle methods, while first-principle methods such as KS-DFT [references 79-82] are too computationally costly to access the nanosecond timescales for large systems size that are needed to realistically describe the HEDM decomposition dynamics. The EMF methods, on the other hand, provide a good compromise and are well suited to performing accurate, long-timescale simulation studies of the reactive processes associated with HEDM explosive initiation. Explosive material such as HMX (Octahydro-1,3,5,7-tetranitro-1,3,5,7-tetrazocine), both in β-crystalline form and in slurries with water can be studied. In addition, the decomposition pathways, reaction dynamics, and energy production following ignition due to high temperatures and shock pressure can be compared between the key steps associated with HMX decomposition.

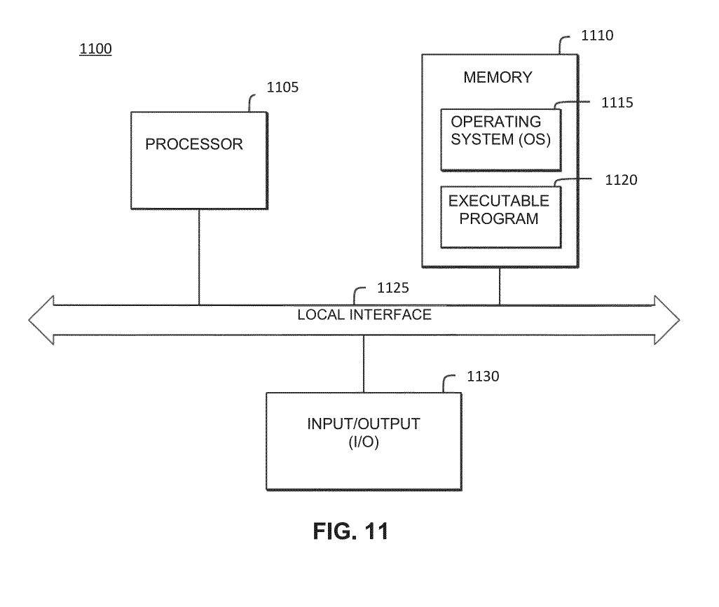

Software realizations of the currently disclosed EMF methods can be developed to enable simulation, study and design of chemical, materials and biological systems. FIG. 11 is an exemplary embodiment of a target hardware (1100) (e.g., a computer system) for implementing the embodiments of the present disclosure, including the embodiment shown in FIG. 10. This target hardware comprises a processor (1105), a memory bank (1110), a local interface bus (1125) and one or more Input/Output devices (1130). The processor can execute one or more instructions related to the implementation of FIG. 1 et al., and as provided by the Operating System (1115) based on some executable program (1120) stored in the memory (1110). These instructions are carried to the processor (1105) via the local interface (1125) and as dictated by some data interface protocol specific to the local interface and the processor (1105). It should be noted that the local interface (1125) is a symbolic representation of several elements such as controllers, buffers (caches), drivers, repeaters and receivers that are generally directed at providing address, control, and/or data connections between multiple elements of a processor based system. In some embodiments the processor (1105) can be fitted with some local memory (cache) where it can store some of the instructions to be performed for some added execution speed. Execution of the instructions by the processor can require usage of some input/output device (1130), such as inputting data from a file stored on a hard disk, inputting commands from a keyboard, inputting data and/or commands from a touchscreen, outputting data to a display, or outputting data to a USB flash drive. In some embodiments, the operating system (1115) facilitates these tasks by being the central element to gathering the various data and instructions required for the execution of the program and provide these to the microprocessor. In some embodiments the operating system is missing, and all the tasks are under direct control of the processor (1105), although the basic architecture of the target hardware device (1100) will remain the same as depicted in FIG. 11. In some embodiments a plurality of processors can be used in a parallel configuration for added execution speed. In such a case, the executable program can be specifically tailored to a parallel execution. Also, in some embodiments the processor (1105) can execute part of the implementation of FIG. 1 et al., and some other part can be implemented using dedicated hardware/firmware placed at an Input/Output location accessible by the target hardware (1100) via local interface (1125). The target hardware (1100) can include a plurality of executable programs (1120), wherein each can run independently or in combination with one another.

The examples set forth above are provided to give those of ordinary skill in the art a complete disclosure and description of how to implement the EMF methods and related methods and to apply the methods to a molecular system of interest, and are not intended to limit the scope of what the Applicants regard as their disclosure. Modifications of the above-described modes for carrying out the disclosure can be used by persons of skill in the art, and are intended to be within the scope of the following claims.

A number of embodiments of the disclosure have been described. The specific embodiments provided herein are examples of useful embodiments of the disclosure and it will be apparent to one skilled in the art that the disclosure can be carried out using a large number of variations of the methods, including basis sets, number of subsystems, and various approximation methods within mean-field level of approximation, set forth either in the present description or readily identifiable to one of skill in the art. The methods disclosed in the current document can be applied to molecular systems and materials of different size varying from tens of atoms to millions of atoms or even more. Thus, the present disclosure is not intended to be limited to the implementations shown herein but is to be accorded the widest scope consistent with the principles and novel features disclosed herein.

The entire disclosure of each document cited (including patents, patent applications, journal articles, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

### REFERENCES

[1] P. Cortona, Self-consistently determined properties of solids without band-structure calculations, Phys. Rev. B 44, 8454-8458 (1991).
[2] T. A. Wesolowski and A. Warshel, Frozen Density Functional Approach for ab-initio Calculations of Solvated Molecules, J. Phys. Chem. 97, 8050 (1993).
[3] N. Govind, Y. A. Wang, A. J. R. da Silva, and E. A. Carter, “Accurate Ab Initio Energetics of Extended Systems via Explicit Correlation Embedded in a Density Functional Environment,” Chem. Phys. Lett., 295, 129 (1998).
[4] T. A. Wesolowski, in Computational Chemistry: Reviews of Current Trends—Vol. 10, pp. 1-82 (World Scientific, Singapore, 2006).
[5] D. Marx and J. Hutter, Ab-initio Molecular Dynamics: Theory and Implementation, Modern Methods and Algorithms in Quantum Chemistry, Forschungzentrum Juelich, NIC Series, vol. 1 (2000).
[6] W. Andreoni and A. Curioni, New advances in chemistry and material science with CPMD and parallel computing, Parallel Computing, 26, 819 (2000).
[7] R. Car and M. Parrinello, Unified approach for molecular-dynamics and density-functional theory, Phys. Rev. Lett. 55, 2471-2474 (1985).
[8] J. M. Herbert and M. Head-Gordon, First-principles, quantum-mechanical simulations of electron solvation by a water cluster, Proc. Natl. Acad. Sci. USA 103, 14282-14287 (2006).
[9] http://www.top500.org/list/2009/11/100
[10] D. R. Bowler, T. Miyazaki, Calculations for millions of atoms with density functional theory: linear scaling shows its potential, Journal of Physics-Condensed Matter 22, 074207 (2010).
[11] C. F. Guerra, J. G. Snijders, G. to Velde, E. J. Baerends, Towards an order-N DFT method, Theoretical Chemistry Accounts 99, 391-403 (1998).
[12] E. Artacho, D. Sanchez-Portal, P. Ordejon, A. Garcia, J. M. Soler, Linear-scaling ab-initio calculations for large and complex systems, Physica Status Solidi B—Basic Research 215, 809-817 (1999).
[13] W. Kohn Density-functional theory for systems of very many atoms, International Journal of Quantum Chemistry 56, 229-232 (1995).
[14] M. V. Fernandez-Serra, E. Artacho, Network equilibration and first-principles liquid water, J. Chem. Phys. 121, 11136-11144 (2004).
[15] W. T. Yang, Direct calculation of electron-density in density-functional theory-Implementation for benzene and tetrapeptide, Phys. Rev. A 44, 7823-7826 (1991).
[16] W. Z. Liang, C. Saravanan, Y. H. Shao, R. Baer, A. T. Bell, and M. Head-Gordon, Improved Fermi operator expansion methods for fast electronic structure calculations, J. Chem. Phys. 119, 4117-4125 (2003).
[17] H.-J. Werner, F. R. Manby, and P. J. Knowles, Fast linear scaling second-order Moller-Plesset perturbation theory (MP2) using local and density fitting approximations, J. Chem. Phys. 118, 8149 (2003).
[18] D. W. Zhang and J. Z. H. Zhang, Molecular fractionation with conjugate caps for full quantum mechanical calculation of protein-molecule interaction energy, J. Chem. Phys. 119, 3599-3605 (2003).
[19] T. L. Beck, Real-space mesh techniques in density-functional theory, Rev. Mod. Phys. 72, 1041-1080 (2000).
[20] A. Warshel and R. M. Weiss, An empirical valence bond approach for comparing reactions in solutions and in enzymes, J. Am. Chem. Soc., 102, 6218-6226 (1980).
[21] A. Warshel, Computer Modeling of Chemical Reactions in Enzymes and in Solutions, (Wiley, New York, 1991).
[22] J. Aqvist and A. Warshel, Simulation of enzyme reactions using valence bond force fields and other hybrid quantum/classical approaches, Chem. Rev., 93, 2523-2544 (1993).
[23] U. W. Schmitt and G. A. Voth, The computer simulation of proton transport in water, J. Chem. Phys. 111, 9361-9381 (1999).
[24] M. Cuma, U. W. Schmitt, and G. A. Voth, A multi-state empirical valence bond model for weak acid dissociation in aqueous solution, J. Phys. Chem. A 105, 2814-2823 (2001).
[25] T. J. F. Day, A. V. Soudackov, M. Cuma, U. W. Schmitt, and G. A. Voth, A second generation multistate empirical valence bond model for proton transport in aqueous systems, J. Chem. Phys. 117, 5839-5849 (2002).
[26] Y. Wu, H. Chen, F. Wang, F. Paesani, and G. A. Voth, An improved multistate empirical valence bond model for aqueous proton solvation and transport, J. Phys. Chem. B 112, 467-482 (2008).
[27] R. Vuilleumier and D. Borgis, An extended empirical valence bond model for describing proton transfer in H+ (H₂O)n clusters and liquid water, Chem. Phys. Lett. 284, 71-77 (1998).
[28] I. S. Ufimtsev, A. G. Kalinichev, T. J. Martinez, and R. J. Kirkpatrick, A multistate empirical valence bond model for solvation and transport simulations of OH— in aqueous solutions, Phys. Chem. Chem. Phys. 11, 9420-9430 (2009).
[29] A. C. T. van Duin, S. Dasgupta, F. Lorant, and W. A. Goddard, III, ReaxFF: A reactive force field for hydrocarbons, J. Phys. Chem. A 105, 9396-9409 (2001).
[30] A. Warshel and M. Karplus, Calculation of Ground and Excited State Potential Surfaces of Conjugated Molecules. I Formulation and Parametrization, J. Am. Chem. Soc. 94,5612 (1972).
[31] A. Warshel and M. Levitt, Theoretical Studies of Enzymatic Reactions: Dielectric Electrostatic and Steric Stabilization of the Carbonium Ion in the Reaction of Lysozyme, J. Mol. Biol., 103, 227 (1976).
[32] R. A. Friesner and V. Guallar, Ab initio quantum chemical and mixed quantum mechanics/molecular mechanics (QM/MM) methods for studying enzymatic catalysis, Annu. Rev. Phys. Chem. 56, 389-427 (2005).
[33] M. Svensson, S. Humbel, R. D. J. Frowese, T. Matsubara, S. Sieber, and K. Morokuma, ONIOM: A multilayered integrated MO+MM method for geometry optimizations and single point energy predictions. A test for Diels-Alder reactions and Pt(P(t-Bu)(3)))(2)+H-2 oxidative addition, J. Phys. Chem. 100, 19357-19363 (1996).
[34] R. E. Rudd and J. Q. Broughton, Concurrent coupling of length scales in solid state systems, Phys. Stat. Sol. B 217, 251-291 (2000).
[35] J. Q. Broughton, F. F. Abraham, B. Bernstein, and E. Kaxiras, Concurrent coupling of length scales: Methodology and application, Phys. Rev. B 60, 2391-2403 (1999).
[36] A. Nakano, M. E. Bachlechner, R. K. Kalia, E. Lidorikis, P. Vashishta, G. Z. Voyiadjis, T. J. Campbell, S. Ogata, and F. Shimojo, Multiscale simulations of nanosystems, Comput. Sci. Eng. 3, 56-66 (2001).
[37] N. Reuter, A. Dejaegere, B. Maigret, and M. Karplus, Frontier bonds in QM/MM methods: A comparison of different approaches, J. Phys. Chem. A 104, 1720-1735 (2000).
[38] F. R. Manby, M. Stella, J. D. Goodpaster, and T. F. Miller III, A simple, exact density-functional-theory embedding scheme, J. Chem. Theory Comput. 8, 2564 (2012).
[39] G. Knizia and G. K. L. Chan, Density Matrix Embedding: A Strong-Coupling Quantum Embedding Theory, J. Chem. Theory Comput. 9, 1428 (2013).
[40] J. T. Margraf, A. Ruland, V. Sgobba, D. M. Guldi, and T. Clark, Theoretical and experimental insights into the surface chemistry of semiconductor quantum dots, Langmuir 29, 49 (2013).
[41] V. V. Albert, S. A. Ivanov, S. Tretiak, and S. Kilina, Electronic Structure of Ligated CdSe Clusters: Dependence on DFT Methodology, J. Phys. Chem. C 115, 32 (2011).
[42] M. M. Hedrick, M. L. Mayo, E. Badaeva, and S. Kilina, First-Principles Studies of the Ground-and Excited-State Properties of Quantum Dots Functionalized by Ru(II)Polybipyridine, J. Phys. Chem. C 117, 35 (2013).
[43] S. Kilina, S. Ivanov, and S. Tretiak, Effect of surface ligands on optical and electronic spectra of semiconductor nanoclusters, J. Am. Chem. Soc. 131, 22 (2009).
[44] S. A. Fischer, A. M. Crotty, S. Kilina, S. A. Ivanov, and S. Tretiak, Passivating ligand and solvent contributions to the electronic properties of semiconductor nanocrystals, Nanoscale 4, 3 (2012).
[45] R. Jose, N. U. Zhanpeisov, H. Fukumura, Y. Baba, and M. Ishikawa, Structure property correlation of CdSe clusters using experimental results and first-principles DFT calculations, J. Am. Chem. Soc. 128, 2 (2006).
[46] I. Robel and V. Subramanian, Quantum Dot Solar Cells: Harvesting Light Energy with CdSe Nanocrystals Molecularly Linked to Mesoscopic TiO2 Films J. Am. Chem. Soc. 128, 7 (2006).
[47] J. L. Dempsey, B. S. Brunschwig, J. R. Winkler, and H. B. Gray, Hydrogen evolution catalyzed by cobaloximes, Acc. Chem. Res. 42, 12, (2009).
[48] B. H. Solis and S. Hammes-Schiffer, Theoretical analysis of mechanistic pathways for hydrogen evolution catalyzed by cobaloximes, Inorg. Chem. 50 21 (2011).
[49] B. H. Solis and S. Hammes-Schiffer, Substituent effects on cobalt diglyoxime catalysts for hydrogen
[50] X. Qi, Y. Fu, L. Liu, and Q. Guo, Ab initio calculations of thermodynamic hydricities of transition-metal hydrides in acetonitrile, Organometallics 26, 17 (2007).
[51] M. Combariza, J. Fermann, and R. Vachet, Are gas-phase reactions of five-coordinate divalent metal ion complexes affected by coordination geometry?, Inorg. Chem. 43, 8 (2004).
[52] M. W. Kanan, Y. Surendranath, and D. G. Nocera, Cobalt-phosphate oxygen-evolving compound, Chem. Soc. Rev. 38, 1 (2009).
[53] T. Wada, K. Tsuge, and K. Tanaka, Syntheses and redox properties of bis(hydroxoruthenium) complexes with quinone and bipyridine ligands. Water-oxidation catalysis, Inorg. Chem. 40, 2 (2001).
[54] M. Tsai, J. Rochford, D. E. Polyansky, T. Wada, K. Tanaka, E. Fujita, and J. T. Muckerman, Characterization of Redox States of Ru(OH2)(Q)(tpy)2+(Q=3,5-di-tert-butyl-1,2-benzoquinone, tpy=2,2:6,2-terpyridine) and Related Species through Experimental and Theoretical Studies, Inorg. Chem. 48, 10 (2009).
[55] M. N. Chaur, F. Melin, A. L. Ortiz, and L. Echegoyen, Chemical, electrochemical, and structural properties of endohedral metallofullerenes, Angew. Chem. 48, 41 (2009).
[56] L. Zhang, A. Popov, S. Yang, S. Klod, P. Rapta, and L. Dunsch, An endohedral redox system in a fullerene cage: the Ce based mixed-metal cluster fullerene Lu2CeN@C80, Phys. Chem. Chem. Phys. 12, 28 (2010).
[57] L. Dunsch and S. Yang, Metal nitride cluster fullerenes: their current state and future prospects, Small 3, 8 (2007).
[58] E. D. Bloch, W. L. Queen, R. Krishna, J. M. Zadrozny, C. M. Brown, and J. R. Long, Hydrocarbon separations in a metal-organic framework with open iron(II) coordination sites, Science 335, 6076 (2012).
[59] Z. Herm, E. Bloch, and J. Long, Hydrocarbon Separations in MetalOrganic Frameworks, Chem. Mater. 26, 1, (2013).
[60] P. Verma, X. Xu, and D. G. Truhlar, Adsorption on Fe-MOF-74 for C1-C3 Hydrocarbon Separation, J. Phys. Chem. C 117, 24 (2013).
[61] P. W. Cooper, Explosives Engineering (New York, Wiley, 1996).
[62] P. G. Carrick and N. T. Williams, Proceedings of the High Energy Density Matter (HEDM) Contractors' Conference (Chantilly, Va., 1997).
[63] D. E. Taylor and B. M. Rice, Quantum-Informed Multiscale M&S for Energetic Materials, Advances in Quantum Chemistry 69 (2013).
[64] J. Giles, News Feature: Collateral Damage, Nature 427, 580-581 (2004).
[65] C. L. Mader, Numerical modeling of explosives and propellants (Boca Raton, Fla., 1998).
[66] D. D. Dlott, Ultrafast spectroscopy of shock waves in molecular materials, Annu. Rev. Phys. Chem. 50, 251-278 (1999).
[67] S. D. McGrane, D. S. Moore, and D. J. Funk, Sub-picosecond shock interferometry of transparent thin films, J. Appl. Phys. 93, 5063-5068 (2003).
[68] Y. Kohno, K. Ueda, and A. Imamura, Molecular dynamics simulations of initial decomposition process on the unique N—N bond in nitramines in the crystalline state, J. Phys. Chem. 100, 4701-4712 (1996).
[69] D. Bedrov, J. B. Hooper, G. D. Smith, and T. D. Sewell, Shock-induced transformation in crystalline RDX: A uniaxial constant-stress Hugoniostat molecular dynamics simulations study, J. Chem. Phys. 131, 034712 (2009).
[70] A. Strachan, A. C. T. van Duin, D. Chakraborty, S. Dasgupta, and W. G. Goddard, III, Shock waves in high-energy density materials: The initial chemical events in nitramine RDX, Phys. Rev. Lett. 91, 098301 (2003).
[71] A. Strachan, E. M. Kober, A. C. T. van Duin, J. Oxgaard, and W. G. Goddard, III, Thermal decomposition of RDX from reactive molecular dynamics, J. Chem. Phys. 122, 054502 (2005).
[72] Y. Wen, X. Xue, X. Zhou, F. Guo, X. Long, Y. Zhou, H. Li, and C. Zhang, Twin Induced Sensitivity Enhancement of HMX versus Shock: A Molecular Reactive Force Field Simulation, J. Phys. Chem. C 117, 46 (2013).
[73] M. R. Manaa, L. E. Fried, C. F. Melius, M. Elstner, and Th. Frauenheim, Decomposition of HMX at extreme conditions: A molecular dynamics simulation, J. Phys. Chem. A 106, 9024 (2002).
[74] M. R. Manaa, E. J. Reed, L. E. Fried, and N. Goldman, Nitrogen-Rich Heterocycles as Reactivity Retardants in Shocked Insensitive Explosives, J. Am. Chem. Soc. 131, 5483 (2009).
[75] D. E. Taylor and B. M. Rice, Quantum-Informed Multiscale M&S for Energetic Materials, Advances in Quantum Chemistry 69 (2013).
[76] E. J. Reed, A. W. Rodriguez, M. R. Manaa, L. E. Fried, and C. M. Tarver, Ultrafast Detonation of Hydrazoic Acid (HN3), Phys. Rev. Lett. 109, 3 (2012).
[77] E. J. Reed, M. Riad Manaa, L. E. Fried, K. R. Glaesemann, and J. D. Joannopoulos, A transient semimetallic layer in detonating nitromethane, Nat. Phys. 4, 1, (2007).
[78] N.-N. Ge, Y.-K. Wei, G.-F. Ji, X.-R. Chen, F. Zhao, and D.-Q. Wei, Initial decomposition of the condensed-phase β-HMX under shock waves: molecular dynamics simulations, J. Phys. Chem. B 116, 46, (2012).
[79] M. R. Manaa, E. J. Reed, L. E. Fried, G. Galli and F. Gygi, Early chemistry in hot and dense nitromethane: Molecular dynamics simulations, J. Chem. Phys. 120, 10146 (2004).
[80] W. Zhu, H. Huang, H. Huang, and H. Xiao, Initial chemical events in shocked octahydro-1,3,5,7-tetranitro-1,3,5,7-tetrazocine: a new initiation decomposition mechanism, J. Chem. Phys. 136, 4, (2012).
[81] D. C. Sorescu and B. M. Rice, Theoretical Predictions of Energetic Molecular Crystals at Ambient and Hydrostatic Compression Conditions Using Dispersion Corrections to Conventional Density Functionals (DFT-D), J. Phys. Chem. C, 114, 14, (2010).
[82] Z. Wu, R. K. Kalia, A. Nakano, and P. Vashishta, Vibrational and thermodynamic properties of β-HMX: a first-principles investigation, J. Chem. Phys. 134, 20 (2011).

1. A method for constructing an energy model for a molecular system, said method comprising:
generating, on a computer, a one-particle basis set for the molecular system;
partitioning the molecular system at a one-particle basis set level into a plurality of partitions comprising a first partition and a second partition;
estimating, on the computer, a total energy of the molecular system by combining mean-field quantum mechanical calculations that involve self-consistent system optimization of a density matrix for a combination of an entirety of the first and second partitions, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost; and
storing, on the computer, at least one value corresponding to the total energy.

2. The method of claim 1, further comprising calculating a derivative of the total energy.

3. The method of claim 2, wherein the calculating the derivative comprises calculating a first order of derivative of the total energy with respect to nuclear coordinates of the molecular system.

4. The method of claim 3, further comprising calculating a force in the molecular system from the first order of derivative.

5. The method of claim 2, wherein the calculating the derivative comprises calculating a second order of derivative of the total energy with respect to nuclear coordinates of the molecular system.

6. The method of claim 1, further comprising calculating stationary points of the total energy of the molecular system from derivatives of the total energy.

7. The method of claim 6, further comprising:
obtaining a reaction rate based on the stationary points of the total energy.

8. The method of claim 1, further comprising:
obtaining, from the estimating, the density matrix for the molecular system, the density matrix describing an electronic mean-field state corresponding to the total energy.

9. The method of claim 1, wherein:
the plurality of partitions further comprises a third partition;
the density matrix for the combination of an entirety of the first and second partitions further comprises the entirety of the third partition; and
the mean-field quantum mechanical calculations are of a third level of computational cost, the third level of computational cost being lower than the second level of computational cost.

10. The method of claim 1, wherein the mean-field quantum calculations at the first level of computational cost comprises Kohn-Sham Density Functional Theory (KS-DFT) with an approximate exchange correlation functional and the mean-field quantum calculations at the second level of computational cost comprises a tight binding (TB) model.

11. The method of claim 10 wherein the TB model comprises density functional TB.

12. The method of claim 1, wherein the mean-field quantum calculations at the first level of computational cost comprises a first Kohn-Sham Density Functional Theory (KS-DFT) at the first level of computational cost and the mean-field quantum calculations at the second level of computational cost comprises a second Kohn-Sham Density Functional Theory (KS-DFT) at the second level of computational cost.

13. The method of claim 1, wherein when the mean-field quantum mechanical calculations comprise at least one of Coulomb integrals and exchange integrals, the at least one of Coulomb integrals and exchange integrals are computed through expansion of an electron density in an auxiliary basis set.

14. The method of claim 1, wherein the one-particle basis set corresponds to a nuclear configuration of the molecular system.

15. The method of claim 1, wherein the one-particle basis set is any one of a plane-wave basis set, a spline basis set, or a wavelet basis set.

16. The method of claim 1, wherein the total energy (E) is defined as
E[D]=trh·D+E_{XC}¹[D]−E_{XC}¹[D^{AA}]+E_{XC}²[D^{AA}]+G¹[D]−G¹[D^{AA}]+G²[D^{AA}]
where D is the density matrix, h is a core Hamiltonian that represents a combination of a kinetic energy of all electrons and an external potential of the molecular system, E_{xc}¹ is an exchange-correlation functional at the second level of computational cost, E_{xc}² is an exchange-correlation functional at the first level of computational cost, G¹ is a contribution from two-electron integrals at the second level of computational cost, G² is a contribution from two-electron integrals at the first level of computational cost, and D^{AA} is a density of the first partition.

17. The method of claim 1, wherein the partitioning further comprises a third partition and the estimating further comprises combining the mean-field quantum mechanical calculations of the first and second partitions with a molecular mechanical calculation corresponding to the third partition.

18. The method of claim 1, further comprising:
determining a unit cell for the molecular system;
replicating the unit cell creating images of the unit cell; and
tiling the unit cell with the images creating a lattice of cells;
wherein the determining further comprises considering environmental influences on the unit cell from the images within the lattice of cells.

19. The method of claim 18, wherein the replicating creates an infinite number of the images, and the lattice of cells is an infinite lattice.

20. The method of claim 1, further comprising:
deriving properties of the molecular system from responses of the density matrix to external fields.

21. The method of claim 1 further comprising:
repeating the generating, the partitioning, the estimating, and the calculating for variants of the molecular system; and
constructing a potential energy surface based on the total energies from the estimatings.

22. A method for selecting a solvent for a compound presenting an acid, the method comprising:
generating, on a computer, a first one-particle basis set associated with a protonated form of the acid;
partitioning the protonated form at a one-particle basis set level into a first partition of the protonated form, the first partition comprising a hydrogen-oxygen bond, and into a second partition of the protonated form;
generating, on the computer, a second one-particle basis set associated with a deprotonated form of the acid;
partitioning the deprotonated form at the one-particle basis set level into a first partition of the deprotonated form, the first partition of the deprotonated form comprising a portion of the deprotonated form of the acid where the hydrogen-oxygen bond of the protonated form was broken to form the deprotonated form, and into a second partition of the protonated form;
estimating, on the computer, a first total energy by combining mean-field quantum mechanical calculations that involve self-consistent system optimization of a first density matrix for a combination of an entirety of the first and second partitions of the protonated form, the mean-field quantum mechanical calculations being of a first level of computational cost for the first partition of the protonated form and of a second level of computational cost for the second partition of the protonated form, the first level of computational cost being higher than the second level of computational cost such that a computational cost of the estimating is lower than if the second level of computational cost were equal to the first level of computational cost;
estimating, on the computer, a second total energy by combining mean-field quantum mechanical calculations that involve self-consistent system optimization of a second density matrix for a combination of an entirety of the first and second partitions of the deprotonated form, the mean-field quantum mechanical calculations being of the first level of computational cost for the first partition of the deprotonated form and of the second level of computational cost for the second partition of the deprotonated form;
calculating a deprotonation energy from the first total energy and the second total energy;
calculating a pKa value of the acid from the deprotonation energy; and
selecting the solvent for the compound based on the pKa value.

23. A method for determining a total energy of a molecular system in an external field, said method comprising:
generating, on a computer, a one-particle basis set associated with the molecular system;
partitioning the molecular system at a one-particle basis set level into a first partition and a second partition;
estimating, on the computer, a total energy of the molecular system by combining mean-field quantum mechanical calculations that involve self-consistent system optimization of a density matrix for a combination of an entirety of the first and second partitions of the one-particle basis set, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost, the self-consistent system optimization including interactions of the system with the external field; and
storing, on the computer, at least one value corresponding to the total energy.

24. The method of claim 23, further comprising calculating a response property of the molecular system from a derivative of the total energy with respect to the external field.

25. The method of claim 23, further comprising:
obtaining, from the estimating, a density matrix for the molecular system, the density matrix describing an electronic mean-field state corresponding to the total energy; and
calculating a response property of the molecular system from a derivative of the density matrix with respect to the external field.

26. The method of claim 23, wherein the one-particle basis set is associated with a nuclear configuration.

27. The method of claim 23, wherein the one-particle basis set is a plane-wave basis set.

28. The method of claim 23, wherein the external field is any one of a scalar field, a vector field, or a tensor field.

29. The method of claim 23, wherein the external field is a time-dependent field.

30. A method for constructing a model of time dependent behavior for a molecular system, said method comprising:
generating, on a computer, a one-particle basis set for a configuration of the molecular system;
partitioning the molecular system at a one-particle basis set level into a first partition and a second partition, wherein the first partition and the second partition each correspond to disjoint subsets of the one-particle basis set;
estimating, on the computer, a total energy of the molecular system by combining mean-field quantum mechanical calculations that involve self-consistent system optimization of a density matrix for a combination of an entirety of the first and second partitions of the basis set, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost; and
calculating forces within the molecular system from a gradient, with respect to nuclear coordinates of the molecular system, of the total energy of the molecular system;
generating a one-particle basis set for a new configuration of the system at a consecutive time step, the new configuration being based on the forces being applied to the molecular system in the configuration; and
repeating the generating, the partitioning, the estimating, and the calculating for the new configuration.

31. The method of claim 30, further comprising:
obtaining a classical molecular dynamics trajectory of at least a portion of the system based on the configurations of the molecular system at each time step.

32. The method of claim 30, further comprising:
obtaining a reaction rate based on the classical molecular dynamics trajectory.

33. A method for optimizing geometry of a molecular system, said method comprising:
generating, on a computer, a one-particle basis set associated with the molecular system of a particular geometry;
partitioning the molecular system of the particular geometry at a one-particle basis set level into a first partition and a second partition;
estimating, on the computer, a total energy of the molecular system by combining mean-field quantum mechanical calculations that involve self-consistent system optimization of a density matrix for a combination of an entirety of the first and second partitions, the mean-field quantum mechanical calculations being of a first level of accuracy for the first partition and a second level of accuracy for the second partition, the first level of accuracy being higher than the second level of accuracy such that a computational cost of the estimating is lower than if the second level of accuracy were equal to the first level of accuracy;
repeating the generating, the partitioning, and the estimating for the molecular system in at least one other geometry; and
optimizing the geometry of the molecular system based on the total energies.

34. The method of claim 33, wherein the optimizing the geometry of the molecular system based on the total energies comprises:
creating a potential energy surface from the total energies; and
determining an optimized geometry by identifying at least one stationary point on the potential energy surface.

35. The method of claim 34, wherein the at least one stationary point comprises at least one saddle point.

36. A method for creating an enzyme from a non-enzymatic protein, said method comprising:
procuring a sample of the non-enzymatic protein;
determining a reaction to be catalyzed by the enzyme;
determining a transition state of the reaction;
building a nuclear configuration associated with a molecular system, the molecular system comprising the sample and the transition state;
generating, on a computer, a one-particle basis set for the nuclear configuration;
partitioning the nuclear configuration at a one-particle basis set level into a first partition and a second partition;
estimating, on the computer, a total energy of the molecular system by combining mean-field quantum mechanical calculations that involve self-consistent system optimization of a density matrix for a combination of an entirety of the first and second partitions, the mean-field quantum mechanical calculations being of a first level of computational cost for the first partition and a second level of computational cost for the second partition, the first level of computational cost being higher than the second level of computational cost such that a computational cost of the estimating is lower than if the second level of computational cost were equal to the first level of computational cost;
storing, on the computer, the total energy;
determining a modification to the non-enzymatic protein;
building a new nuclear configuration associated with a new molecular system, the new molecular system comprising: the transition state, and the non-enzymatic protein with the modification;
partitioning the new nuclear configuration at a one-particle basis set level into a new first partition and a new second partition;
estimating, on the computer, a new total energy of the new nuclear configuration by combining mean-field quantum mechanical calculations that involve self-consistent system optimization of a new density matrix for a combination of an entirety of the new first and new second partitions, the mean-field quantum mechanical calculations being of the first level of computational cost for the new first partition and the second level of computational cost for the new second partition;
storing, on the computer, the new total energy;
determining if the new total energy is lower than the total energy; and
if the new total energy is lower than the total energy, applying the modification to the non-enzymatic protein.
